(19) United States
(12) Patent Application Publication
(10) Pub. No.: US 2023/0324658 A1
(43) Pub. Date: Oct. 12, 2023

(54) OPTICAL SYSTEM, OPTICAL APPARATUS AND METHOD FOR MANUFACTURING THE OPTICAL SYSTEM

(71) Applicant: Nikon Corporation, Minato-ku, Tokyo (JP)

(72) Inventor: Mami MURATANI, Tokyo (JP)

(21) Appl. No.: 18/022,136

(22) PCT Filed: Jul. 30, 2021
(86) PCT No.: PCT/JP2021/028398

§ 371 Date: Feb. 17, 2023

(30) Foreign Application Priority Data
Aug. 18, 2020 (JP) 2020-138020

(51) Int. Cl. G02B 15/24; G02B 13/00; G02B 9/64

(52) U.S. Cl. CPC G02B 15/24; G02B 13/002; G02B 13/006; G02B 9/64

(57) ABSTRACT

This optical system (OL) comprises, in order from the object side along the optical axis, a front group (GA), a diaphragm (S), and a rear group (GB). The rear group (GB) has a first focusing lens group (GF1) that has a negative refractive power and is positioned furthest toward the object side in the rear group (GB), and a second focusing lens group (GF2) that has a negative refractive power and is positioned closer to the image-surface side than the first focusing lens group (GF1). The first focusing lens group (GF1) and the second focusing lens group (GF2) move in respectively different trajectories toward the image-surface side along the optical axis during focusing from an object at infinity to a close-distance object.

### TECHNICAL FIELD

The present invention relates to an optical system, an optical apparatus, and a method for manufacturing the optical system.

### TECHNICAL BACKGROUND

Conventionally, there has been proposed an optical system that performs focusing by moving a plurality of lens groups along an optical axis (for example, see Patent literature 1). In such an optical system, the focusing lens groups are increased in weight, and it is difficult to suppress aberration fluctuations during focusing.

### PRIOR ARTS LIST

### Patent Document

Patent literature 1: Japanese Laid-Open Patent Publication No. 2012-155228(A)

### SUMMARY OF THE INVENTION

An optical system according to a first aspect of the present invention consists of a front group, an aperture stop, and a rear group that are disposed in order from an object along an optical axis, wherein the rear group comprises a first focusing lens group disposed closest to the object of the rear group and having negative refractive power, and a second focusing lens group disposed closer to an image surface than the first focusing lens group and having negative refractive power, and upon focusing from an infinity object to a short-distance object, the first focusing lens group and the second focusing lens group move toward the image surface along the optical axis at respective different trajectories.

An optical system according to a second aspect of the present invention comprises a preceding lens group having positive refractive power, a first focusing lens group having negative refractive power, a positive lens group having positive refractive power, a second focusing lens group having negative refractive power, and a final lens group that are disposed in order from an object along an optical axis, wherein upon focusing from an infinity object to a short-distance object, the first focusing lens group and the second focusing lens group move toward an image surface along the optical axis at respective different trajectories.

An optical apparatus according to the present invention comprises the optical system.

A method for manufacturing an optical system consisting of, a front group, an aperture stop, and a rear group that are disposed in order from an object along an optical axis according to a first aspect of the present invention comprises a step of disposing the front group, the aperture stop and the rear group in a lens barrel so that; the rear group comprises a first focusing lens group disposed closest to the object of the rear group and having negative refractive power, and a second focusing lens group disposed closer to an image surface than the first focusing lens group and having negative refractive power, and upon focusing from an infinity object to a short-distance object, the first focusing lens group and the second focusing lens group move toward the image surface along the optical axis at respective different trajectories.

A method for manufacturing an optical system comprising a preceding lens group having positive refractive power, a first focusing lens group having negative refractive power, a positive lens group having positive refractive power, a second focusing lens group having negative refractive power, and a final lens group that are disposed in order from an object along an optical axis, according to a second aspect of the present invention comprises a step of disposing the preceding lens group, the first focusing lens group, the positive lens group, the second focusing lens group and the final lens group in a lens barrel so that ; upon focusing from an infinity object to a short-distance object, the first focusing lens group and the second focusing lens group move toward an image surface along the optical axis at respective different trajectories.

### BRIEF DESCRIPTION OF THE DRAWINGS

FIG. 1 is a diagram showing a lens configuration of an optical system according to Example 1;

FIG. 2A is a graph showing various aberrations of the optical system according to Example 1 upon focusing on infinity;

FIG. 2B is a graph showing various aberrations of the optical system according to Example 1 upon focusing on a short-distance object;

FIG. 3 is a diagram showing a lens configuration of an optical system according to Example 2;

FIG. 4A is a graph showing various aberrations of the optical system according to Example 2 upon focusing on infinity;

FIG. 4B is a graph showing various aberrations of the optical system according to Example 2 upon focusing on a short-distance object;

FIG. 5 is a diagram showing a lens configuration of an optical system according to Example 3;

FIG. 6A is a graph showing various aberrations of the optical system according to Example 3 upon focusing on infinity;

FIG. 6B is a graph showing various aberrations of the optical system according to Example 3 upon focusing on a short-distance object;

FIG. 7 is a diagram showing a lens configuration of an optical system according to Example 4;

FIG. 8A is a graph showing various aberrations of the optical system according to Example 4 upon focusing on infinity;

FIG. 8B is a graph showing various aberrations of the optical system according to Example 4 upon focusing on a short-distance object;

FIG. 9 is a diagram showing a lens configuration of an optical system according to Example 5;

FIG. 10A is a graph showing various aberrations of the optical system according to Example 5 upon focusing on infinity;

FIG. 10B is a graph showing various aberrations of the optical system according to Example 5 upon focusing on a short-distance object;

FIG. 11 is a diagram showing a lens configuration of an optical system according to Example 6;

FIG. 12A is a graph showing various aberrations of the optical system according to Example 6 upon focusing on infinity;

FIG. 12B is a graph showing various aberrations of the optical system according to Example 6 upon focusing on a short-distance object;

FIG. 13 is a diagram showing a lens configuration of an optical system according to Example 7;

FIG. 14A is a graph showing various aberrations of the optical system according to Example 7 upon focusing on infinity;

FIG. 14B is a graph showing various aberrations of the optical system according to Example 7 upon focusing on a short-distance object;

FIG. 15 is a diagram showing a lens configuration of an optical system according to Example 8;

FIG. 16A is a graph showing various aberrations of the optical system according to Example 8 upon focusing on infinity;

FIG. 16B is a graph showing various aberrations of the optical system according to Example 8 upon focusing on a short-distance object;

FIG. 17 is a diagram showing a lens configuration of an optical system according to Example 9;

FIG. 18A is a graph showing various aberrations of the optical system according to Example 9 upon focusing on infinity;

FIG. 18B is a graph showing various aberrations of the optical system according to Example 9 upon focusing on a short-distance object;

FIG. 19 is a diagram showing a lens configuration of an optical system according to Example 10;

FIG. 20A is a graph showing various aberrations of the optical system according to Example 10 upon focusing on infinity in a wide-angle end state;

FIG. 20B is a graph showing various aberrations of the optical system according to Example 10 upon focusing on a short-distance object in a wide-angle end state;

FIG. 21A is a graph showing various aberrations of the optical system according to Example 10 upon focusing on infinity in a telephoto end state;

FIG. 21B is a graph showing various aberrations of the optical system according to Example 10 upon focusing on a short-distance object in a telephoto end state;

FIG. 22 is a diagram showing a configuration of a camera comprising the optical system according to each of the embodiments;

FIG. 23 is a flowchart showing a method for manufacturing the optical system according to a first embodiment; and

FIG. 24 is a flowchart showing a method for manufacturing the optical system according to a second embodiment.

### DESCRIPTION OF THE EMBODIMENTS

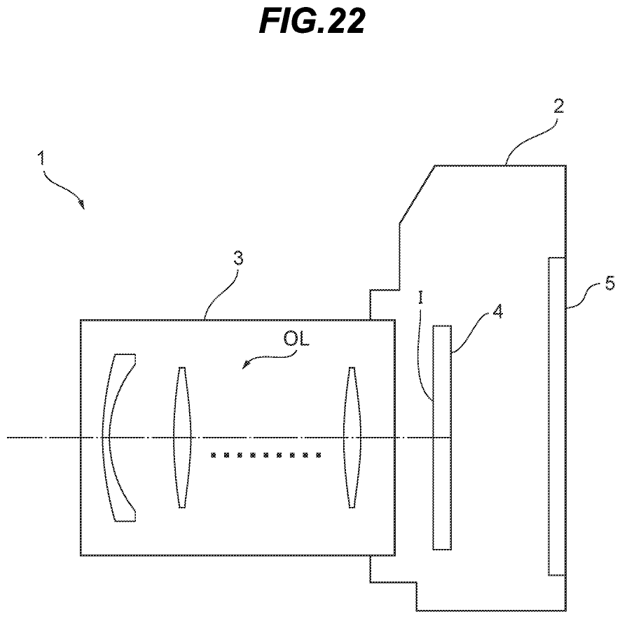

Preferred Embodiments according to the present invention will be described below. First, a camera (optical apparatus) comprising an optical system according to each of the embodiments will be described with reference to FIG. 22. As shown in FIG. 22, a camera 1 comprises a main body 2 and a photographing lens 3 mounted onto the main body 2. The main body 2 comprises an imaging element 4, a main body control part (not shown) that controls an operation of a digital camera, and a liquid crystal display 5. The photographing lens 3 comprises an optical system OL comprises a plurality of lens groups and a lens position control mechanism (not shown) that controls a position of each of the lens groups. The lens position control mechanism is configured by a sensor that detects the position of the lens group, a motor that moves the lens group back and forth along an optical axis, and a control circuit that drives the motor, for example.

Light emitted from a subject is collected by the optical system OL of the photographing lens 3, and reaches an image surface I of the imaging element 4. The light reaching the image surface I from the subject is photoelectrically converted by the imaging element 4, and is recorded as digital image data in a memory (not shown). The digital image data recorded in the memory can be displayed on the liquid crystal display 5 according to a user's operation. The camera may be a mirrorless camera or a single lens reflex type camera with a quick return mirror. In addition, the optical system OL shown in FIG. 22 schematically shows an optical system provided in the photographing lens 3, and a lens configuration of the optical system OL is not limited to such a configuration.

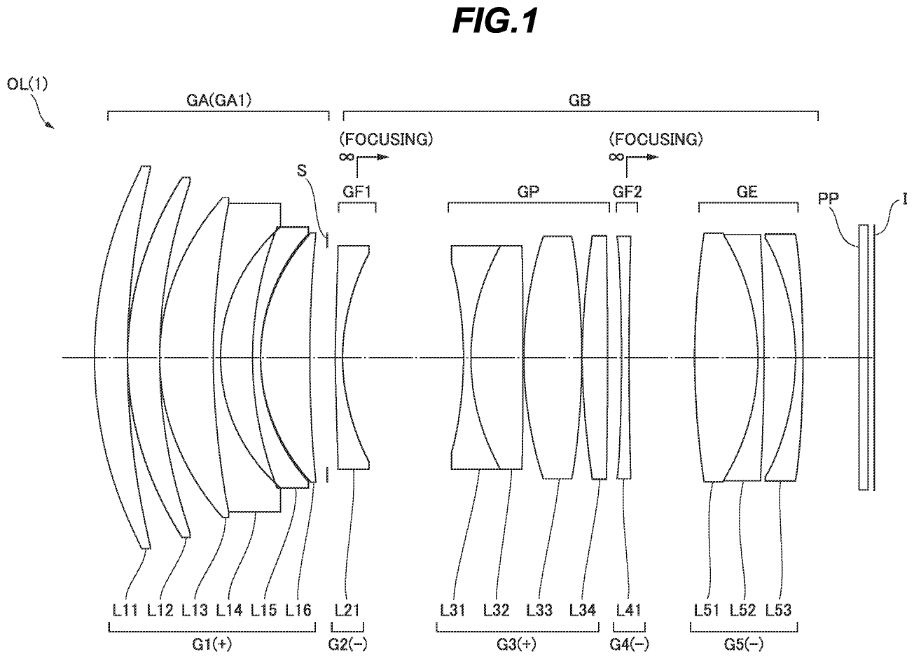

Next, an optical system according to a first embodiment will be described. An optical system OL(1) as an example of the optical system OL according to the first embodiment consists of, in order from an object along the optical axis, a front group GA, a stop (aperture stop) S, and a rear group GB, as shown in FIG. 1. The rear group GB comprises a first focusing lens group GF1 disposed closest to the object of the rear group GB and having negative refractive power and a second focusing lens group GF2 disposed closer to the image surface than the first focusing lens group GF1 and having negative refractive power. Upon focusing from an infinity object to a short-distance object, the first focusing lens group GF1 and the second focusing lens group GF2 move toward the image surface along the optical axis at different trajectories, respectively.

According to the first embodiment, it is possible to obtain an optical system with less aberration fluctuation during focusing and an optical apparatus comprising the optical system. Further, since the aberration fluctuation during focusing is small, it is possible to achieve good optical performance with large diameter. Since a weight of each of the focusing lens groups can be reduced, it is possible to obtain an optical system compatible with high-speed autofocusing (AF). Since a driving mechanism of each of the focusing lens groups can be simplified, it is possible to reduce sensitivity of optical performance to manufacturing errors.

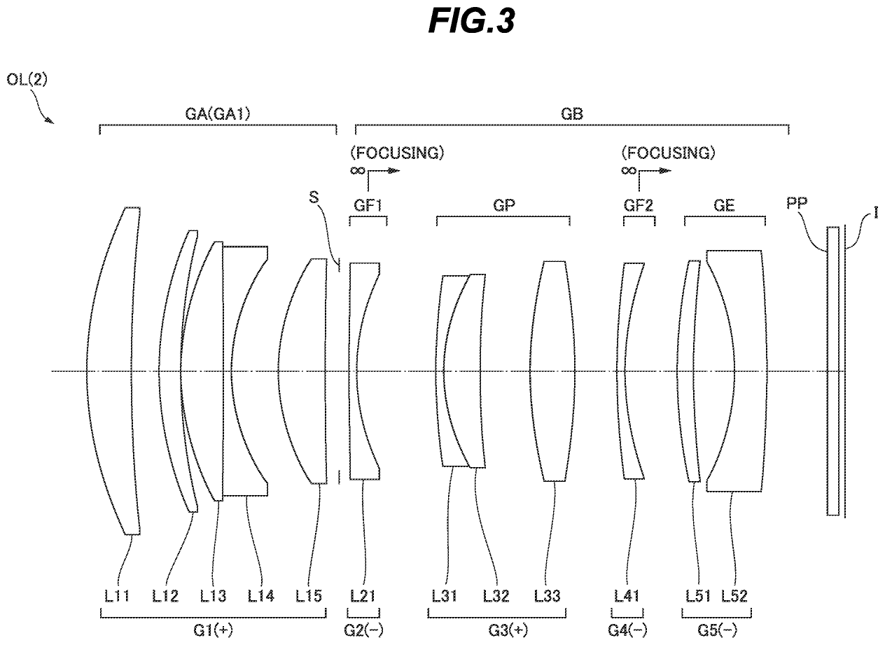

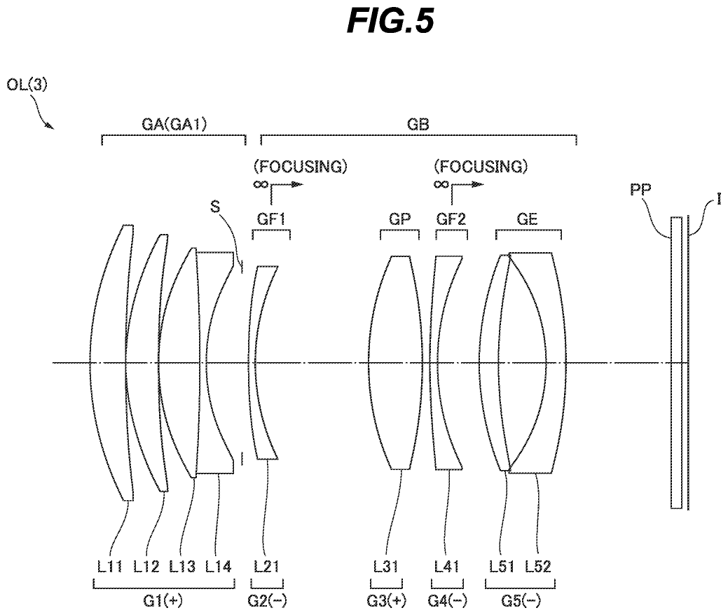

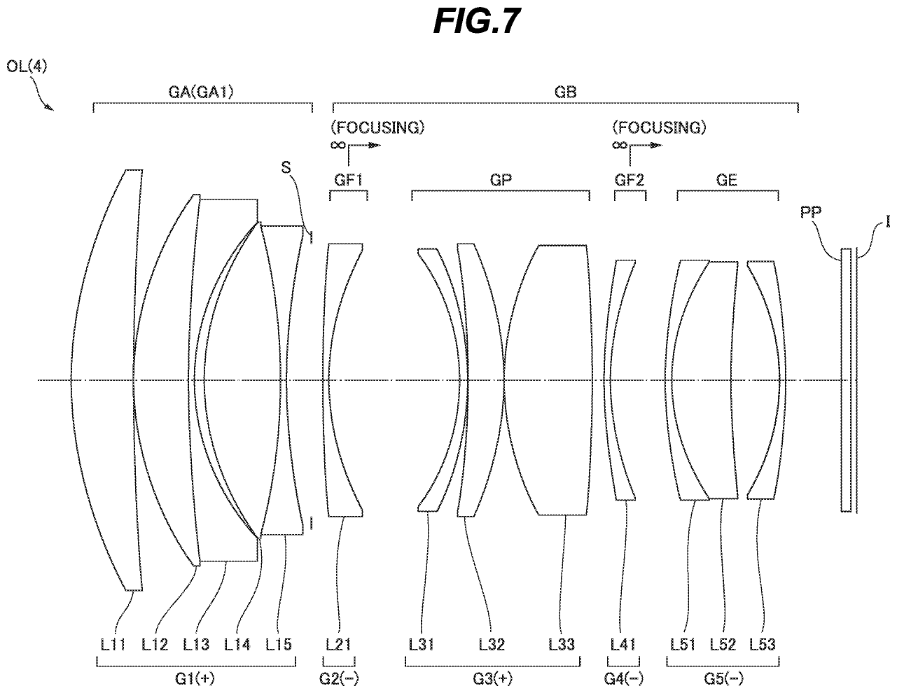

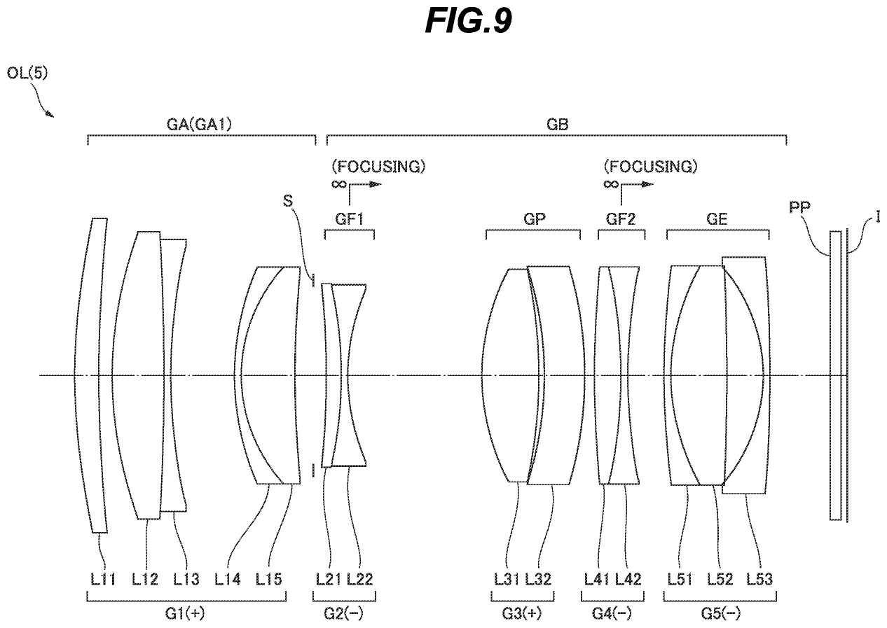

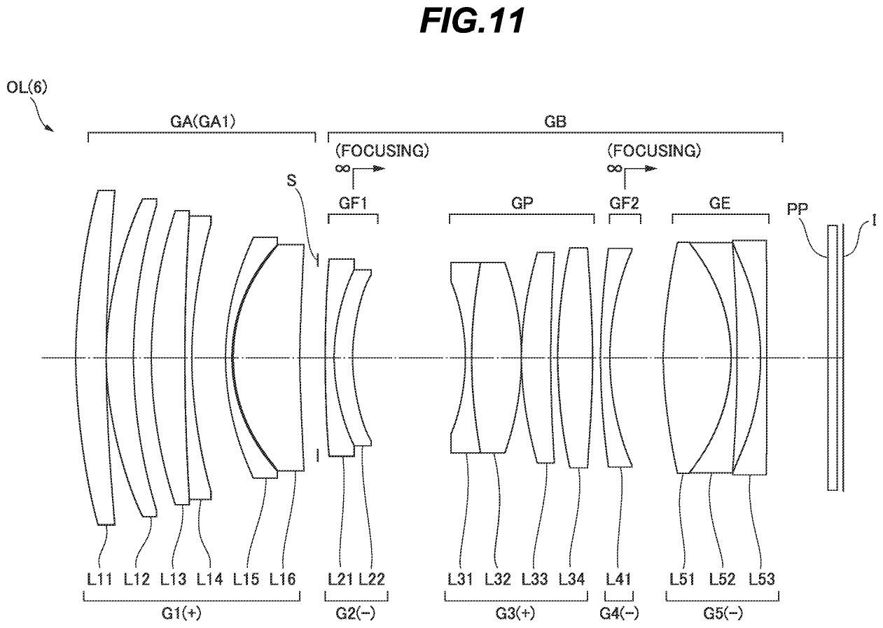

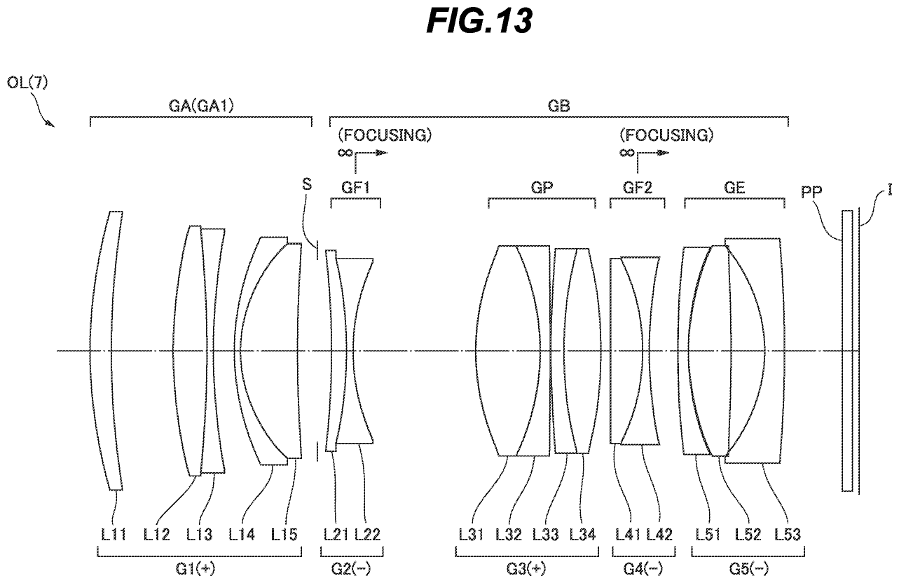

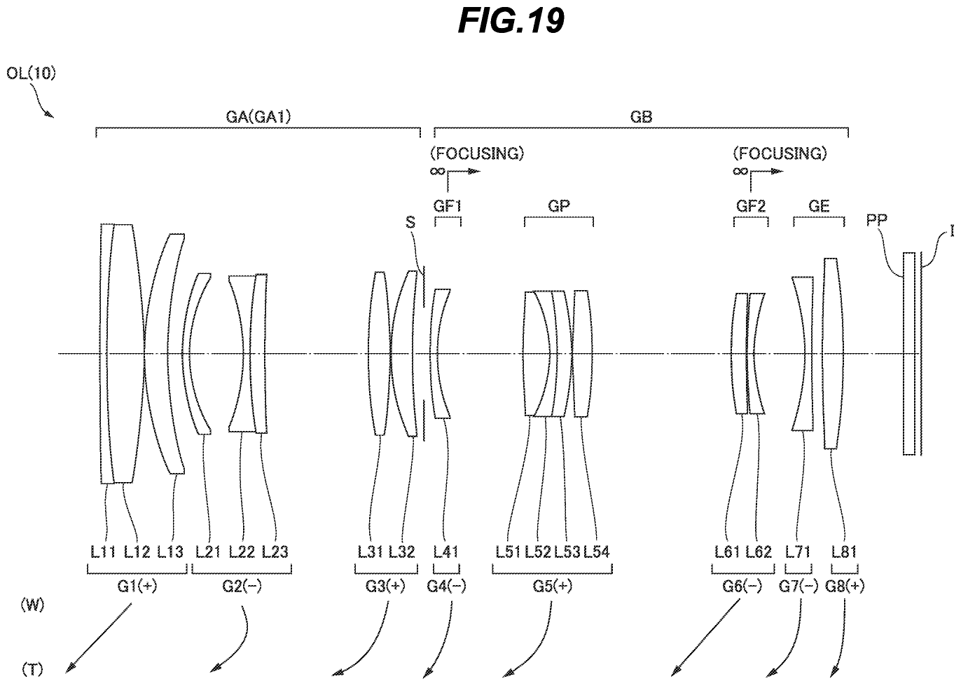

The optical system OL according to the first embodiment may be a zoom optical system OL(2) shown in FIG. 3, an optical system OL(3) shown in FIG. 5, an optical system OL(4) shown in FIG. 7, or an optical system OL(5) shown in FIG. 9. Further, the optical system OL according to the first embodiment may be a zoom optical system OL(6) shown in FIG. 11, an optical system OL(7) shown in FIG. 13, or an optical system OL(10) shown in FIG. 19.

The optical system OL according to the first embodiment preferably satisfies the following conditional expression (1).

0.30<STL/TL<0.90 (1)

where, STL: a distance on the optical axis from the aperture stop S to the image surface I

TL: an entire length of the optical system OL

The conditional expression (1) defines an appropriate relationship between the distance on the optical axis from the aperture stop S to the image surface I and the entire length of the optical system OL. In a case of satisfying the conditional expression (1), a position of an exit pupil can be analogized, and a position of a stop can be defined within an appropriate range. Further, it is possible to prevent fluctuations in angle of view according to a change in back focusing due to the manufacturing errors. In each of the embodiments, the entire length of the optical system OL is defined as a distance along the optical axis (air equivalent distance) from a lens surface closest to the object in the optical system OL upon focusing on infinity to the image surface I.

When a corresponding value in the conditional expression (1) is below a lower limit value, the exit pupil becomes closer to the image surface I, whereby an angle of inclination of light beams incident on the image surface I becomes steeper, and the fluctuations in angle of view are likely to occur due to the change in back focusing caused by the manufacturing errors. When the lower limit value in the conditional expression (1) is set to 0.33, 0.35, 0.38, 0.40, 0.43, 0.45, 0.48, 0.50, and 0.52, an effect of the present embodiment can be made more reliable.

When the corresponding value in the conditional expression (1) exceeds an upper limit value, the position of the aperture stop S is not appropriate, whereby a cut ratio of an upper light beam and a lower light beam at the aperture stop S becomes unbalanced, resulting in a so-called single aperture stop. Further, since the entire length of the optical system OL is too short, aberration correction becomes difficult. When the upper limit value in the conditional expression (1) is set to 0.88, 0.85, 0.83, 0.80, 0.78, and 0.76, the effect of the present embodiment can be made more reliable.

In the optical system OL according to the first embodiment, preferably, the rear group GB comprises a positive lens group GP disposed between the first focusing lens group GF1 and the second focusing lens group GF2 and having positive refractive power, and a position of the positive lens group GP is fixed with respect to the image surface I upon focusing from the infinity object to the short-distance object. Thus, it is possible to satisfactorily correct a spherical aberration and a Petzval sum, for example.

In the optical system OL according to the first embodiment, preferably, the front group GA consists of a preceding lens group GA1 having positive refractive power, and the rear group GB comprises a positive lens group GP disposed between the first focusing lens group GF1 and the second focusing lens group GF2 and having positive refractive power and a final lens group GE disposed closer to the image surface than the second focusing lens group GF2. Thus, when a plurality of focusing lens groups are disposed closer to the image surface than the aperture stop S, it is possible to easily align axes of the plurality of focusing lens groups during alignment, and to reduce sensitivity of optical performance relative to manufacturing errors. Further, by movement of the plurality of focusing lens groups during focusing, it is possible to reduce the weight of the focusing lens groups and to effectively prevent aberration fluctuations during focusing.

Next, an optical system according to a second embodiment will be described. An optical system OL(1) as an example of an optical system OL according to the second embodiment comprises, in order from the object along the optical axis, a preceding lens group GA1 having positive refractive power, a first focusing lens group GF1 having negative refractive power, a positive lens group GP having positive refractive power, a second focusing lens group GF2 having negative refractive power, and a final lens group GE, as shown in FIG. 1. Upon focusing from an infinity object to a short-distance object, the first focusing lens group GF1 and the second focusing lens group GF2 move toward the image surface along the optical axis at different trajectories, respectively.

According to the second embodiment, it is possible to obtain an optical system with less aberration fluctuation during focusing and an optical apparatus comprising the optical system. Further, since the aberration fluctuation during focusing is small, it is possible to achieve good optical performance with large diameter. Since a weight of each of the focusing lens groups can be reduced, it is possible to obtain an optical system compatible with high-speed autofocusing (AF). Since a driving mechanism of each of the focusing lens groups can be simplified, it is possible to reduce sensitivity of optical performance to manufacturing errors.

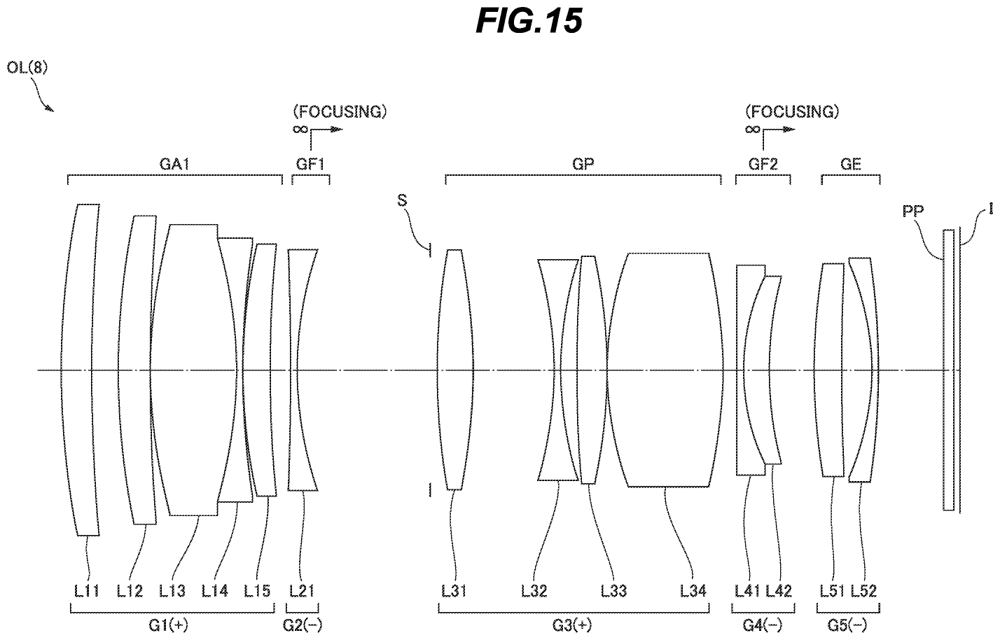

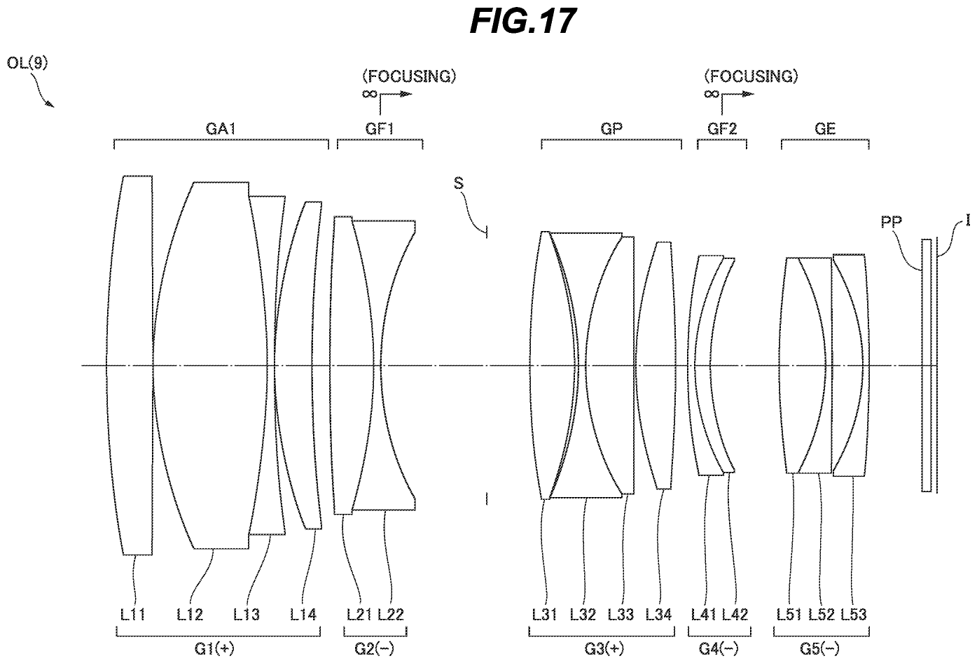

The optical system OL according to the second embodiment may be a zoom optical system OL(2) shown in FIG. 3, an optical system OL(3) shown in FIG. 5, an optical system OL(4) shown in FIG. 7, or an optical system OL(5) shown in FIG. 9. Further, the optical system OL according to the second embodiment may be a zoom optical system OL(6) shown in FIG. 11, an optical system OL(7) shown in FIG. 13, an optical system OL(8) shown in FIG. 15, an optical system OL(9) shown in FIG. 17, or an optical system OL(10) shown in FIG. 19.

In the optical system OL according to the second embodiment, preferably, a stop (aperture stop) S is disposed between the preceding lens group GA1 and the first focusing lens group GF1. Thus, it is possible to effectively narrow the light beams incident on the focusing lens group, and to reduce the size and weight of the focusing lens group. Further, it is possible to easily align axes of the plurality of focusing lens groups during alignment, and to reduce sensitivity of optical performance relative to manufacturing errors. Further, it is possible to satisfactorily correct fluctuations in angle of view during focusing.

The optical system OL according to the second embodiment preferably satisfies the conditional expression (1) described above. In a case of satisfying the conditional expression (1), as in the first embodiment, a position of an exit pupil can be analogized, and a position of a stop can be defined within an appropriate range. In addition, it is possible to prevent fluctuations in angle of view according to a change in back focusing due to the manufacturing errors. When the lower limit value in the conditional expression (1) is set to 0.33, 0.35, 0.38, 0.40, 0.43, 0.45, 0.48, 0.50, and 0.52, the effect of the present embodiment can be made more reliable. Further, when the upper limit value in the conditional expression (1) is set to 0.88, 0.85, 0.83, 0.80, 0.78, and 0.76, the effect of the present embodiment can be made more reliable.

The optical system OL according to the first and second embodiments preferably satisfies the following conditional expression (2).

0.50<fA/f<2.00 (2)

where, fA: a focal length of the preceding lens group GA1

f: a focal length of the optical system OL

The conditional expression (2) defines an appropriate relationship between the focal length of the preceding lens group GA1 and the focal length of the optical system OL. In a case of satisfying the conditional expression (2), chromatic aberration can be satisfactorily corrected, and the entire length of the optical system OL can be shortened.

When a corresponding value in the conditional expression (2) is out of the above range, it is difficult to correct the chromatic aberration, and it is difficult to shorten the entire length of the optical system OL. When a lower limit value in the conditional expression (2) is set to 0.55, 0.60, 0.65, 0.70, 0.75, 0.80, 0.85, 0.90, and 0.95, the effect of each of the embodiments can be made more reliable. Further, when an upper limit value in the conditional expression (2) is set to 1.90, 1.80, 1.75, 1.70, 1.65, 1.60, 1.55, 1.50, and 1.45, the effect of each of the embodiments can be made more reliable.

The optical system OL according to the first and second embodiments preferably satisfies the following conditional expression (3).

0.50<fA/(−fF1)<1.50 (3)

where, fA: a focal length of the preceding lens group GA1

fF1: a focal length of the first focusing lens group GF1

The conditional expression (3) defines an appropriate relationship between the focal length of the preceding lens group GA1 and the focal length of the first focusing lens group GF1. In a case of satisfying the conditional expression (3), it is possible to reduce aberration fluctuations and fluctuations in angle of view during focusing.

When a corresponding value in the conditional expression (3) is out of the above range, it is difficult to reduce the aberration fluctuations and the fluctuations in angle of view during focusing. When a lower limit value in the conditional expression (3) is set to 0.53, 0.55, 0.58, 0.60, 0.63, 0.65, 0.68, 0.70, and 0.73, the effect of each of the embodiments can be made more reliable.

Further, when an upper limit value in the conditional expression (3) is set to 1.48, 1.45, 1.43, 1.40, 1.38, 1.35, and 1.33, the effect of each of the embodiments can be made more reliable.

The optical system OL according to the first and second embodiments preferably satisfies the following conditional expression (4).

0.35<fB/(−fF1)<1.50 (4)

where, fB: a combined focal length of the lens groups disposed closer to the image surface than the first focusing lens group GF1

fF1: a focal length of the first focusing lens group GF1

The conditional expression (4) defines an appropriate relationship between the combined focal length of the lens groups disposed closer to the image surface than the first focusing lens group GF1 and the focal length of the first focusing lens group GF1. In a case of satisfying the conditional expression (4), it is possible to reduce aberration fluctuations and fluctuations in angle of view during focusing.

When a corresponding value in the conditional expression (4) is out of the above range, it is difficult to reduce the aberration fluctuations and fluctuations in angle of view during focusing. When a lower limit value in the conditional expression (4) is set to 0.38, 0.40, 0.43, 0.45, 0.48, 0.50, 0.53, 0.55, 0.58, and 0.60, the effect of each of the embodiments can be made more reliable. Further, when an upper limit value in the conditional expression (4) is set to 1.45, 1.40, 1.35, 1.30, 1.25, 1.20, 1.18, 1.15, 1.13, and 1.10, the effect of each of the embodiments can be made more reliable.

The optical system OL according to the first and second embodiments preferably satisfies the following conditional expression (5).

−2.00<(−fE)/f<15.00 (5)

where, fE: a focal length of the final lens group GE

f: a focal length of the optical system OL

The conditional expression (5) defines an appropriate relationship between the focal length of the final lens group GE and the focal length of the optical system OL. In a case of satisfying the conditional expression (5), it is possible to prevent shading and to shorten the entire length of the optical system OL.

When a corresponding value in the conditional expression (5) is out of the above range, it is difficult to prevent the shading and to shorten the entire length of the optical system OL. When a lower limit value in the conditional expression (5) is set to −1.80, −1.50, −1.00, −0.50, −0.10, 0.10, 0.50, 0.65, 0.80, and 0.90, the effect of each of the embodiments can be made more reliable. Further, when an upper limit value in the conditional expression (5) is set to 14.80, 12.00, 10.00, 8.50, 7.50, 6.00, 5.00, 4.50, and 4.00, the effect of each of the embodiments can be made more reliable.

The optical system OL according to the first and second embodiments preferably satisfies the following conditional expression (6).

−1.00<fP/(−fE)<1.50 (6)

where, fP: a focal length of the positive lens group GP

fE: a focal length of the final lens group GE

The conditional expression (6) defines an appropriate relationship between the focal length of the positive lens group GP and the focal length of the final lens group GE. In a case of satisfying the conditional expression (6), it is possible to satisfactorily prevent the aberration fluctuations during focusing and to make the exit pupil far from the image surface I.

When a corresponding value in the conditional expression (6) is out of the above range, it is difficult to prevent the aberration fluctuations during focusing. When a lower limit value in the conditional expression (6) is set to −0.80, −0.50, −0.25, −0.10, 0.01, 0.05, 0.12, and 0.15, the effect of each of the embodiments can be made more reliable. Further, when an upper limit value in the conditional expression (6) is set to 1.40, 1.25, 1.00, 0.85, 0.70, 0.65, 0.60, and 0.55, the effect of each of the embodiments can be made more reliable.

The optical system OL according to the first and second embodiments preferably satisfies the following conditional expression (7).

1.10<(−fF1)/fP<3.20 (7)

where, fF1: a focal length of the first focusing lens group GF1

fP: a focal length of the positive lens group GP

The conditional expression (7) defines an appropriate relationship between the focal length of the first focusing lens group GF1 and the focal length of the positive lens group GP. In a case of satisfying the conditional expression (7), it is possible to satisfactorily prevent an occurrence in spherical aberration and longitudinal chromatic aberration.

When a corresponding value in the conditional expression (7) is out of the above range, it is difficult to correct the spherical aberration and the longitudinal chromatic aberration. When a lower limit value in the conditional expression (7) is set to 1.15, 1.20, 1.25, 1.30, 1.33, 1.35, 1.38, 1.40, 1.43, and 1.45, the effect of each of the embodiments can be made more reliable. Further, when an upper limit value in the conditional expression (7) is set to 3.15, 3.10, 3.05, and 3.00, the effect of each of the embodiments can be made more reliable.

The optical system OL according to the first and second embodiments preferably satisfies the following conditional expression (7).

0.30<fP/f<1.00 (7)

where, fP: a focal length of the positive lens group GP

f: a focal length of the optical system OL

The conditional expression (7) defines an appropriate relationship between the focal length of the positive lens group GP and the focal length of the optical system OL. In a case of satisfying the conditional expression (7), it is possible to satisfactorily correct a spherical aberration and a Petzval sum, for example.

When a corresponding value in the conditional expression (7) is out of the above range, it is difficult to correct the spherical aberration and the Petzval sum, for example. When a lower limit value in the conditional expression (7) is set to 0.33, 0.35, 0.38, 0.40, and 0.43, the effect of each of the embodiments can be made more reliable. Further, when an upper limit value in the conditional expression (7) is set to 0.98, 0.95, 0.93, 0.90, and 0.88, the effect of each of the embodiments can be made more reliable.

In the optical system OL according to the first and second embodiments, the positive lens group GP preferably comprises a negative lens, a first positive lens, and a second positive lens which are disposed in order from the object along the optical axis. Thus, it is possible to reduce the size of the optical system OL and to make the exit pupil far from the image surface I. Further, various aberrations including the spherical aberration can be satisfactorily corrected.

The optical system OL according to the first and second embodiments preferably satisfies the following conditional expression (9).

0.10<fF1/fF2<2.00 (9)

where, fF1: a focal length of the first focusing lens group GF1

fF2: a focal length of the second focusing lens group GF2

The conditional expression (9) defines an appropriate relationship between the focal length of the first focusing lens group GF1 and the focal length of the second focusing lens group GF2. In a case of satisfying the conditional expression (9), it is possible to satisfactorily correct a spherical aberration and a curvature of field, for example.

When a corresponding value in the conditional expression (9) is out of the above range, it is difficult to correct the spherical aberration and the curvature of field, for example. When a lower limit value in the conditional expression (9) is set to 0.13, 0.15, 0.18, 0.20, 0.23, and 0.25, the effect of each of the embodiments can be made more reliable. Further, when an upper limit value in the conditional expression (9) is set to 1.98, 1.95, 1.93, 1.90, 1.75, 1.50, 1.40, 1.25, 1.10, and 1.00, the effect of each of the embodiments can be made more reliable.

The optical system OL according to the first and second embodiments preferably satisfies the following conditional expression (10).

0.50<f/(−fF1)<1.80 (10)

where, f: a focal length of the optical system OL

fF1: a focal length of the first focusing lens group GF1

The conditional expression (10) defines an appropriate relationship between the focal length of the optical system OL and the focal length of the first focusing lens group GF1. In a case of satisfying the conditional expression (10), it is possible to satisfactorily correct a chromatic aberration and a curvature of field, for example.

When a corresponding value in the conditional expression (10) is out of the above range, it is difficult to correct the chromatic aberration and the curvature of field, for example. When a lower limit value in the conditional expression (10) is set to 0.53, 0.55, 0.58, 0.60, 0.63, 0.65, 0.68, 0.70, 0.73, and 0.75, the effect of each of the embodiments can be made more reliable. Further, when an upper limit value in the conditional expression (10) is set to 1.78, 1.75, 1.73, 1.70, 1.50, 1.40, and 1.20, the effect of each of the embodiments can be made more reliable.

In the optical system OL according to the first and second embodiments, the first focusing lens group GF1 preferably consists of one negative lens component. Thus, since the first focusing lens group GF1 is reduced in weight, it is possible to perform focusing from the infinity object to the short-distance object at high speed. In each of the embodiments, a lens component indicates a single lens or a cemented lens.

The optical system OL according to the first and second embodiments preferably satisfies the following conditional expression (11).

−2.50<(rF12+rF11)/(rF12−rF11)<0.00 (11)

where, rF11: a radius of curvature of the lens surface closest to the object in the first focusing lens group GF1

rF12: a radius of curvature of the lens surface closest to the image surface in the first focusing lens group GF1

The conditional expression (11) defines an appropriate range for a shape factor of lenses constituting the first focusing lens group GF1. In a case of satisfying the conditional expression (11), it is possible to satisfactorily correct a spherical aberration and a coma aberration.

When a corresponding value in the conditional expression (11) is out of the above range, it is difficult to correct the spherical aberration and the coma aberration. When a lower limit value in the conditional expression (11) is set to −2.45, −2.40, −2.35, −2.30, −2.28, −2.25, and −2.23, the effect of each of the embodiments can be made more reliable. Further, when an upper limit value in the conditional expression (11) is set to −0.05, −0.10, −0.15, −0.20, −0.25, −0.30, −0.35, −0.40, −0.45, −0.50, and −0.55, the effect of each of the embodiments can be made more reliable.

In the optical system OL according to the first and second embodiments, the second focusing lens group GF2 preferably consists of one negative lens component. Thus, since the second focusing lens group GF2 is reduced in weight, it is possible to perform focusing from the infinity object to the short-distance object at high speed.

The optical system OL according to the first and second embodiments preferably satisfies the following conditional expression (12).

0.05<BF/TL<0.80 (12)

where, Bf: back focusing of the optical system OL

TL: the entire length of the optical system OL

The conditional expression (12) defines an appropriate relationship between the back focusing of the optical system OL and the entire length of the optical system OL. In a case of satisfying the conditional expression (12), it is possible to satisfactorily correct a spherical aberration and a coma aberration. In each of the embodiments, the back focusing of the optical system OL is defined as a distance (air equivalent distance) from the lens surface closest to the image surface in the optical system OL to the image surface I upon focusing on infinity.

When a corresponding value in the conditional expression (12) is below a lower limit value, the exit pupil becomes closer to the image surface I, whereby vignetting of light beams occurs on the image surface I. Attempting to avoid the vignetting of light beams may result in difficulty in correcting a non-axial aberration, particularly, a coma aberration, which is undesirable. When the lower limit value in the conditional expression (12) is set to 0.06 and 0.07, the effect of each of the embodiments can be made more reliable.

When the corresponding value in the conditional expression (12) exceeds an upper limit value, since the entire length of the optical system OL is too short, it is difficult to correct a spherical aberration and a coma aberration. Further, since the back focusing of the optical system OL is too long, the optical system OL is increased in size. When the upper limit value in the conditional expression (12) is set to 0.75, 0.70, 0.65, 0.50, 0.40, 0.35, 0.30, and 0.25, the effect of each of the embodiments can be made more reliable.

The optical system OL according to the first and second embodiments preferably satisfies the following conditional expression (13).

−0.80<(rR2+rR1)<2.50 (13)

where, rR1: a radius of curvature of the lens surface on the object side in the lens disposed closest to the image surface in the optical system OL

rR2: a radius of curvature of the lens surface on the image surface in the lens disposed closest to the image surface in the optical system OL

The conditional expression (13) defines an appropriate range for a shape factor of lenses disposed closest to the image surface in the optical system OL. In a case of satisfying the conditional expression (13), it is possible to satisfactorily correct a coma aberration and to prevent ghosting.

When a corresponding value in the conditional expression (13) is out of the above range, it is difficult to correct the coma aberration and to prevent the ghosting. When a lower limit value in the conditional expression (13) is set to −0.75, −0.70, −0.65, −0.60, −0.50, −0.30, 0.30, 0.50, 0.80, and 0.95, the effect of each of the embodiments can be made more reliable. Further, when an upper limit value in the conditional expression (13) is set to 2.45, 2.35, 2.15, 2.00, 1.85, and 1.70, the effect of each of the embodiments can be made more reliable.

The optical system OL according to the first and second embodiments preferably satisfies the following conditional expression (14).

0.01<1/βF1<0.60 (14)

where, βF1: a lateral magnification of the first focusing lens group GF1 upon focusing on an infinity object

The conditional expression (14) defines an appropriate range for the lateral magnification of the first focusing lens group GF1 upon focusing on an infinity object. In a case of satisfying the conditional expression (14), it is possible to satisfactorily correct various aberrations including a spherical aberration and a curvature of field upon focusing on an infinity object.

When a corresponding value in the conditional expression (14) is out of the above range, it is difficult to correct various aberrations including the spherical aberration and the curvature of field upon focusing on an infinity object. When a lower limit value in the conditional expression (14) is set to 0.02, 0.05, and 0.08, the effect of each of the embodiments can be made more reliable. Further, when an upper limit value in the conditional expression (14) is set to 0.58, 0.55, 0.53, 0.50, 0.48, 0.45, and 0.43, the effect of each of the embodiments can be made more reliable.

The optical system OL according to the first and second embodiments preferably satisfies the following conditional expression (15).

0.50<1/βF2<0.95 (15)

where, βF2: a lateral magnification of the second focusing lens group GF2 upon focusing on an infinity object

The conditional expression (15) defines an appropriate range for the lateral magnification of the second focusing lens group GF2 upon focusing on an infinity object. In a case of satisfying the conditional expression (15), it is possible to satisfactorily correct various aberrations including a spherical aberration and a curvature of field upon focusing on an infinity object.

When a corresponding value in the conditional expression (15) is out of the above range, it is difficult to correct various aberrations including the spherical aberration and the curvature of field upon focusing on an infinity object. When a lower limit value in the conditional expression (15) is set to 0.53, 0.55, 0.58, and 0.60, the effect of each of the embodiments can be made more reliable. Further, when an upper limit value in the conditional expression (15) is set to 0.94, 0.92, 0.90, and 0.85, the effect of each of the embodiments can be made more reliable.

The optical system OL according to the first and second embodiments preferably satisfies the following conditional expression (16).

{βF1+(1/βF)}⁻²<0.20 (16)

where, βF1: a lateral magnification of the first focusing lens group GF1 upon focusing on an infinity object

The conditional expression (16) defines an appropriate range for the lateral magnification of the first focusing lens group GF1 upon focusing on an infinity object. In a case of satisfying the conditional expression (16), it is possible to satisfactorily correct various aberrations including a spherical aberration and a curvature of field upon focusing on an infinity object.

When a corresponding value in the conditional expression (16) is out of the above range, it is difficult to correct various aberrations including the spherical aberration and the curvature of field upon focusing on an infinity object. When an upper limit value in the conditional expression (16) is set to 0.18, 0.16, 0.15, and 0.14, the effect of each of the embodiments can be made more reliable.

The optical system OL according to the first and second embodiments preferably satisfies the following conditional expression (17).

{βF2+(1+βF2)}⁻²≤0.25 (17)

where, βF2: a lateral magnification of the second focusing lens group GF2 upon focusing on an infinity object

The conditional expression (17) defines an appropriate range for the lateral magnification of the second focusing lens group GF2 upon focusing on an infinity object. In a case of satisfying the conditional expression (17), it is possible to satisfactorily correct various aberrations including a spherical aberration and a curvature of field upon focusing on an infinity object. When a corresponding value in the conditional expression (17) is out of the above range, it is difficult to correct various aberrations including the spherical aberration and the curvature of field upon focusing on an infinity object.

The optical system OL according to the first and second embodiments preferably satisfies the following conditional expression (18).

0.15<MF1/MF2<0.80 (18)

where, MF1: an absolute value of the movement amount of the first focusing lens group GF1 upon focusing from the infinity object to the short-distance object

MF2: an absolute value of the movement amount of the second focusing lens group GF2 upon focusing from the infinity object to the short-distance object

The conditional expression (18) defines an appropriate relationship between the movement amount of the first focusing lens group GF1 and the movement amount of the second focusing lens group GF2 upon focusing from the infinity object to the short-distance object. In a case of satisfying the conditional expression (18), it is possible to satisfactorily correct a spherical aberration, a coma aberration, and a curvature of field.

When a corresponding value in the conditional expression (18) is out of the above range, it is difficult to correct the spherical aberration, the coma aberration, and the curvature of field. When a lower limit value in the conditional expression (18) is set to 0.16, 0.18, 0.20, and 0.22, the effect of each of the embodiments can be made more reliable. Further, when an upper limit value in the conditional expression (18) is set to 0.78, 0.75, 0.73, 0.70, and 0.68, the effect of each of the embodiments can be made more reliable.

The optical system OL according to the first and second embodiments preferably satisfies the following conditional expression (19).

20.00°<2ω<40.00° (19)

where, 2ω: a full angle of view of the optical system OL

The conditional expression (19) defines an appropriate range for a full angle of view of the optical system OL. In a case of satisfying the conditional expression (19), it is possible to obtain an optical system with a wide angle of view, which is preferable. When a lower limit value in the conditional expression (19) is set to 22.00°, 24.00°, 26.00°, and 27.00°, the effect of each of the embodiments can be made more reliable. Further, when an upper limit value in the conditional expression (19) is set to 38.00°, 37.00°, and 36.00°, the effect of each of the embodiments can be made more reliable.

The optical system OL according to the first and second embodiments preferably satisfies the following conditional expression (20).

0.08<BF/f<1.20 (20)

where, Bf: a back focusing of the optical system OL

f: a focal length of the optical system OL

The conditional expression (20) defines an appropriate relationship between the back focusing of the optical system OL and the focal length of the optical system OL. In a case of satisfying the conditional expression (20), it is possible to obtain an optical system with short back focusing while satisfactorily preventing an occurrence of various aberrations. When a lower limit value in the conditional expression (20) is set to 0.09, 0.10, 0.11, and 0.12, the effect of each of the embodiments can be made more reliable. Further, when an upper limit value in the conditional expression (20) is set to 1.18, 1.15, 1.13, 1.10, 1.08, 1.05, and 1.03, the effect of each of the embodiments can be made more reliable.

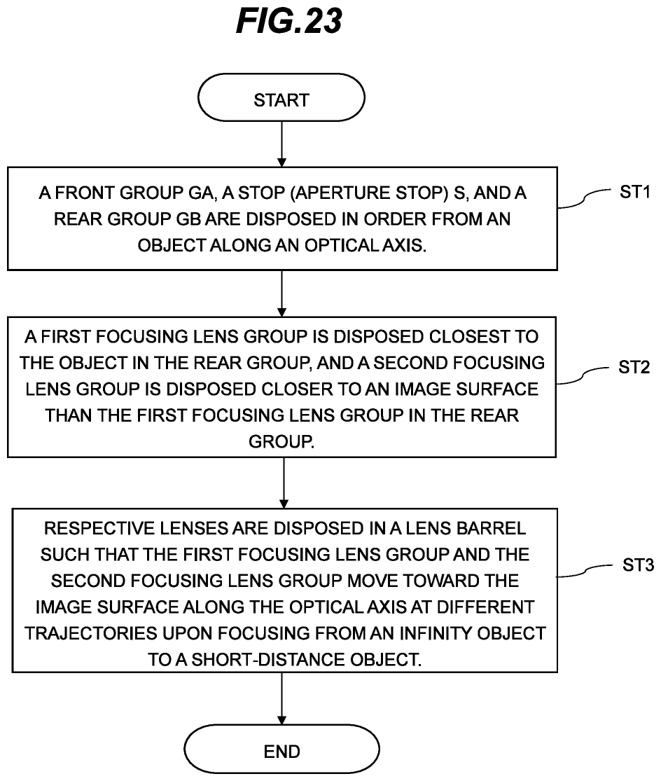

Subsequently, a method for manufacturing the optical system OL according to the first embodiment will be summarized with reference to FIG. 23. First, a front group GA, a stop (aperture stop) S, and a rear group GB are disposed in order from an object along an optical axis (step ST1). Next, a first focusing lens group GF1 having negative refractive power is disposed closest to the object in the rear group GB, and a second focusing lens group GF2 having negative refractive power is disposed closer to an image surface than the first focusing lens group GF1 in the rear group GB (step ST2). Then, respective lenses are disposed in a lens barrel such that the first focusing lens group GF1 and the second focusing lens group GF2 move toward the image surface along the optical axis at different trajectories upon focusing from an infinity object to a short-distance object (step ST3). According to such a manufacturing method, it is possible to manufacture an optical system with less aberration fluctuation upon focusing.

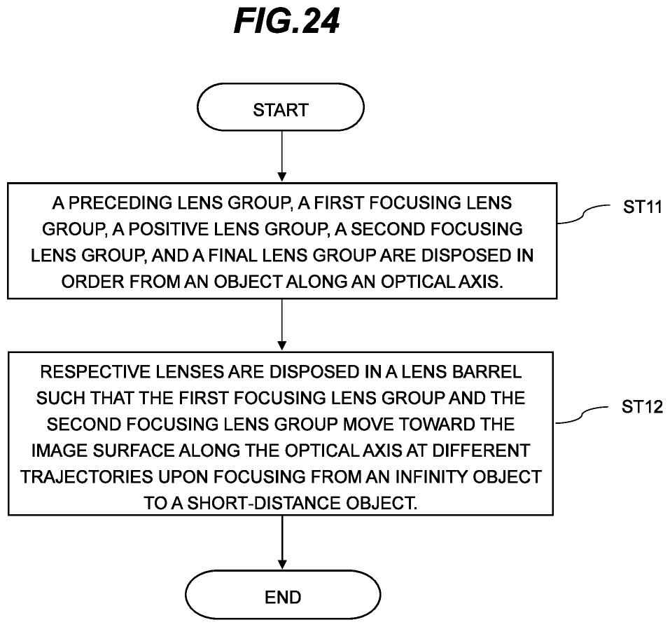

Subsequently, a method for manufacturing the optical system OL according to the second embodiment will be summarized with reference to FIG. 24. First, a preceding lens group GA1 having positive refractive power, a first focusing lens group GF1 having negative refractive power, a positive lens group GP having positive refractive power, a second focusing lens group GF2 having negative refractive power, and a final lens group GE are disposed in order from an object along an optical axis (step ST11). Then, respective lenses are disposed in a lens barrel such that the first focusing lens group GF1 and the second focusing lens group GF2 move toward the image surface along the optical axis at different trajectories upon focusing from an infinity object to a short-distance object (step ST12). According to such a manufacturing method, it is possible to manufacture an optical system with less aberration fluctuation upon focusing.

### EXAMPLES

Optical systems OL according to Examples of each of the embodiments will be described below with reference to the drawings. Examples corresponding to the first embodiment are Examples 1 to 7 and 10, and Examples corresponding to the second embodiment are Examples 1 to 10. FIGS. 1, 3, 5, 7, 9, 11, 13, 15, 17, and 19 are cross sectional views showing configurations and refractive power distributions of optical systems OLs {OL(1) to OL(10)} according to Examples 1 to 10. In the cross sectional views of the optical systems OL(1) to OL(10) according to Examples 1 to 10, a direction of movement along the optical axis of each lens group upon focusing from an infinity object to a short-distance object is indicated by an arrow. In the cross sectional view of the optical system OL(10) according to Example 10, a direction of movement of each lens group along the optical axis upon zooming from a wide-angle end state (W) to a telephoto end state (T) is indicated by an arrow.

In the drawings (FIGS. 1, 3, 5, 7, 9, 11, 13, 15, 17, and 19), each lens group is represented by a combination of a symbol G and a number, and each lens is represented by a combination of a symbol L and a number. In this case, in order to prevent complication due to an increase in types and numbers of symbols and numerals, the lens groups and the like are represented independently using combinations of symbols and numerals for each Example. Therefore, even when the same combinations of symbols and numerals are used in Examples, it does not mean that Examples have the same configuration.

Tables 1 to 10 are shown below, of which Table 1 is a table showing data in Example 1, Table 2 is a table showing data in Example 2, Table 3 is a table showing data in Example 3, Table 4 is a table showing data in Example 4, Table 5 is a table showing data in Example 5, Table 6 is a table showing data in Example 6, Table 7 is a table showing data in Example 7, Table 8 is a table showing data in Example 8, Table 9 is a table showing data in Example 9, and Table 10 is a table showing data in Example 10. In each Example, a d-line (wavelength λ=587.6 nm) and a g-line (wavelength λ=435.8 nm) are selected as targets for calculating aberration characteristics.

In a table of [General data], a symbol f indicates a focal length of the entire lens system, a symbol FNO indicates an F-number, a symbol 2ω indicates an angle of view (represented by unit of ° (degree), ω being a half angle of view), and a symbol Y indicates an image height. A symbol TL indicates a distance obtained by adding Bf to a distance from the frontmost lens surface to the final lens surface along the optical axis upon focusing on infinity, and a symbol Bf indicates a distance (back focusing) from the final lens surface to the image surface I along the optical axis upon focusing on infinity. Further, a symbol TL(a) indicates a distance (air equivalent distance) from the lens surface closest to the object in the optical system to the image surface I along the optical axis upon focusing on infinity. A symbol Bf(a) indicates a distance (air equivalent distance) from the lens surface closest to the image surface in the optical system to the image surface I along the optical axis upon focusing on infinity. When the optical system is a zoom optical system, these values are shown for each zooming state of a wide-angle end (W), an intermediate focal length (M), and a telephoto end (T).

In a table of [General data], a symbol fA indicates a focal length of the preceding lens group. A symbol fB indicates a combined focal length of the lens groups disposed closer to the image surface than the first focusing lens group. A symbol βF1 indicates a lateral magnification of the first focusing lens group upon focusing on an infinity object. A symbol βF2 indicates a lateral magnification of the second focusing lens group upon focusing on an infinity object. A symbol MF1 indicates an absolute value of the movement amount of the first focusing lens group upon focusing from the infinity object to the short-distance object. A symbol MF2 indicates an absolute value of the movement amount of the second focusing lens group upon focusing from the infinity object to the short-distance object.

In a table of [Lens data], a surface number indicates the order of optical surfaces from the object in a direction in which light beams travel, a symbol R indicates a radius of curvature (the surface of which center of curvature is located on the image side is a positive value) of each optical surface, a symbol D indicates a surface distance along the optical axis from each optical surface to the next optical surface (or the image surface), a symbol nd indicates a refractive index of a material of an optical member with respect to the d-line, and a symbol vd indicates an Abbe number of a material of an optical member with respect to the d-line. A symbol “∞” in the radius of curvature indicates a plane or an aperture, and an (stop S) indicates an aperture stop S. The refractive index (nd=1.00000) of air is not described.

In a table of [Variable distance data], the surface distance in the table of [Lens data] indicates a surface distance for a surface number i marked with (Di). When the optical system is not a zoom optical system, in the table of [Variable distance data], a symbol f indicates a focal length of the entire lens system and a symbol β indicates a photographing magnification. Further, a symbol DO indicates a distance from the object to the optical surface closest to the object in the optical system. When the optical system is a zoom optical system, the surface distance in the table of [Lens data] indicates a surface distance for a surface number i marked with (Di) in the table of [Variable distance data] corresponding to each zooming state of a wide-angle end (W), an intermediate focal length (M), and a telephoto end (T).

In a table of [Lens group data], a starting surface (surface closest to the object) and a focal length of each lens group are indicated.

Unless otherwise specified, a unit of “mm” is used for the focal length f, the radius of curvature R, the surface distance D, and other lengths in all data values, but is not limited thereto from the reason that the optical system can obtain the equivalent optical performance even when being proportionally enlarged or proportionally reduced.

The description regarding the table is common to all Examples, and duplicated description will not be given below.

### Example 1

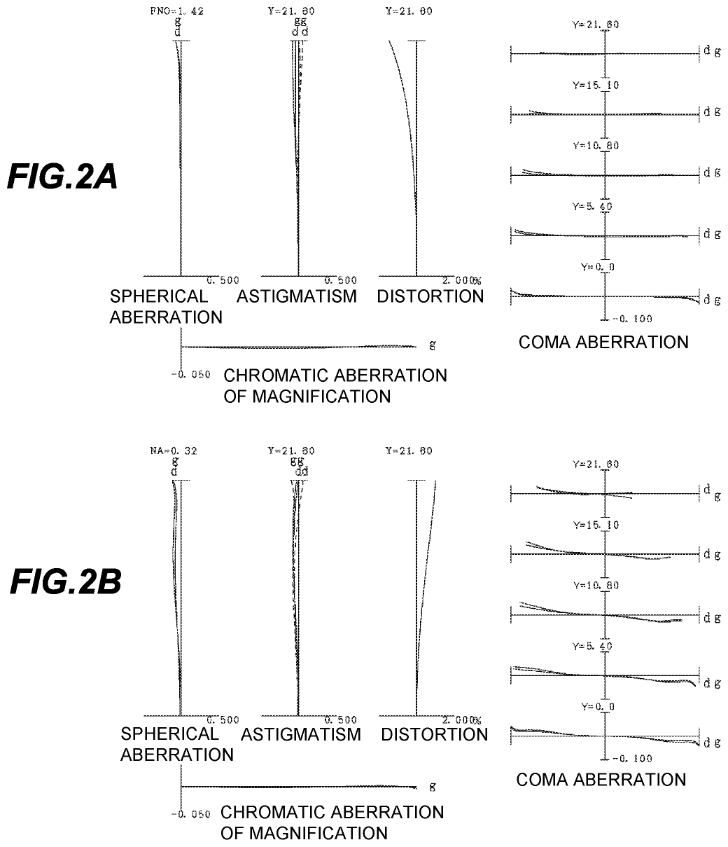

Example 1 will be described with reference to FIGS. 1 and 2 and Table 1. FIG. 1 is a diagram showing a lens configuration of the optical system according to Example 1. The optical system OL(1) according to Example 1 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I. A sign (+) or (−) attached to each of the lens group symbols indicates refractive power of each of the lens groups, which is applied for all the following Examples.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a positive meniscus lens L12 having a convex surface facing an object, a cemented lens in which a positive meniscus lens L13 having a convex surface facing an object and a negative meniscus lens L14 having a convex surface facing an object are cemented, a negative meniscus lens L15 having a convex surface facing an object, and a positive meniscus lens L16 having a convex surface facing an object. The second lens group G2 comprises a negative meniscus lens L21 having a convex surface facing an object.

The third lens group G3 comprises, in order from the object along the optical axis, a cemented lens in which a biconcave negative lens L31 and a biconvex positive lens L32 are cemented, a biconvex positive lens L33, and a biconvex positive lens L34. The fourth lens group G4 comprises a biconcave negative lens L41.

The fifth lens group G5 comprises, in order from the object along the optical axis, a cemented lens in which a biconvex positive lens L51 and a negative meniscus lens L52 having a concave surface facing an object are cemented, and a negative meniscus lens L53 having a concave surface facing an object. An image surface I is disposed on an image side of the fifth lens group G5. A parallel plate PP is disposed between the fifth lens group G5 and the image surface I.

The following Table 1 lists values of data of the optical system according to Example 1.

TABLE 1
[General Data]

| | |
|---|---|
| f = 87.000 | fA = 89.351 |
| FNO = 1.424 | fB = 64.417 |
| 2ω = 28.285 | βF1 = 2.601 |
| Y = 21.600 | βF2 = 1.125 |
| TL = 129.013 | MF1 = 12.719 |
| Bf = 1.000 | MF2 = 8.237 |
| TL (a) = 128.468 | |
| Bf (a) = 11.168 | |

[Lens Data]

| Surface | | | | |
|---|---|---|---|---|
| Number | R | D | nd | νd |
| 1 | 69.6342 | 5.430 | 1.9591 | 17.47 |
| 2 | 132.1539 | 0.116 | | |
| 3 | 55.3642 | 5.244 | 2.0010 | 29.13 |
| 4 | 89.6665 | 0.100 | | |
| 5 | 40.4445 | 8.778 | 1.5503 | 75.49 |
| 6 | 140.0000 | 1.200 | 1.8548 | 24.80 |
| 7 | 29.5861 | 5.360 | | |
| 8 | 63.3783 | 1.200 | 1.9229 | 20.88 |
| 9 | 31.8132 | 0.100 | | |
| 10 | 31.2943 | 8.078 | 1.7292 | 54.67 |
| 11 | 237.3897 | 2.787 | | |
| 12 | ∞ | (D12) | | (Aperture |
| | | | | Stop S) |
| 13 | 438.3400 | 1.200 | 1.5163 | 64.14 |
| 14 | 38.4472 | (D14) | | |
| 15 | −65.9934 | 1.200 | 1.7783 | 23.91 |
| 16 | 39.9168 | 8.673 | 1.8040 | 46.53 |
| 17 | −723.3882 | 0.100 | | |
| 18 | 70.0000 | 9.587 | 1.8160 | 46.62 |
| 19 | −124.9732 | 0.100 | | |
| 20 | 135.5192 | 4.257 | 1.9591 | 17.47 |
| 21 | −631.3761 | (D21) | | |
| 22 | −255.5306 | 1.200 | 1.6989 | 30.13 |
| 23 | 1196.1373 | (D23) | | |
| 24 | 148.6618 | 10.553 | 1.9591 | 17.47 |
| 25 | −40.7482 | 1.000 | 1.8929 | 20.36 |
| 26 | −348.6817 | 5.247 | | |
| 27 | −43.6865 | 1.200 | 1.7783 | 23.91 |
| 28 | −175.9036 | 9.113 | | |
| 29 | ∞ | 1.600 | 1.5168 | 63.88 |
| 30 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 87.000 | β = −0.034 | β = −0.126 |
| D0 | ∞ | 2570.805 | 728.956 |
| D12 | 1.500 | 4.805 | 14.219 |
| D14 | 19.979 | 16.674 | 7.260 |
| D21 | 2.293 | 4.042 | 10.530 |
| D23 | 10.820 | 9.071 | 2.583 |

[Lens Group Data]

| | First | Focal |
|---|---|---|
| Group | surface | length |
| G1 | 1 | 89.351 |
| G2 | 13 | −81.705 |
| G3 | 15 | 54.836 |
| G4 | 22 | −301.138 |
| G5 | 24 | −611.471 |

FIG. 2A is a graph showing various aberrations of the optical system according to Example 1 upon focusing on infinity. FIG. 2B is a graph showing various aberrations of the optical system according to Example 1 upon focusing on a short-distance object. In each of the aberrations upon focusing on infinity, a symbol FNO indicates an F-number, and a symbol Y indicates an image height. In each of the aberrations upon focusing on a short-distance object, a symbol NA indicates a numerical aperture, and a symbol Y indicates an image height. A spherical aberration graph shows an F-number or a numerical aperture value corresponding to the maximum aperture diameter, an astigmatism graph and a distortion graph show the maximum value of the image height, and a coma aberration graph shows a value of each image height. A symbol d indicates a d-line (wavelength λ=587.6 nm), and a symbol g indicates a g-line (wavelength λ=435.8 nm). In the astigmatism graph, a solid line indicates a sagittal image surface, and a broken line indicates a meridional image surface. In aberration graphs of Examples shown below, the same reference numerals as in the present Example are used, and duplicated description will not be given.

From the graphs showing various aberrations, it can be seen that the optical system according to Example 1 is satisfactorily corrected for various aberrations and has excellent imaging performance over the entire range from upon focusing on infinity to upon focusing on a short-distance object.

### Example 2

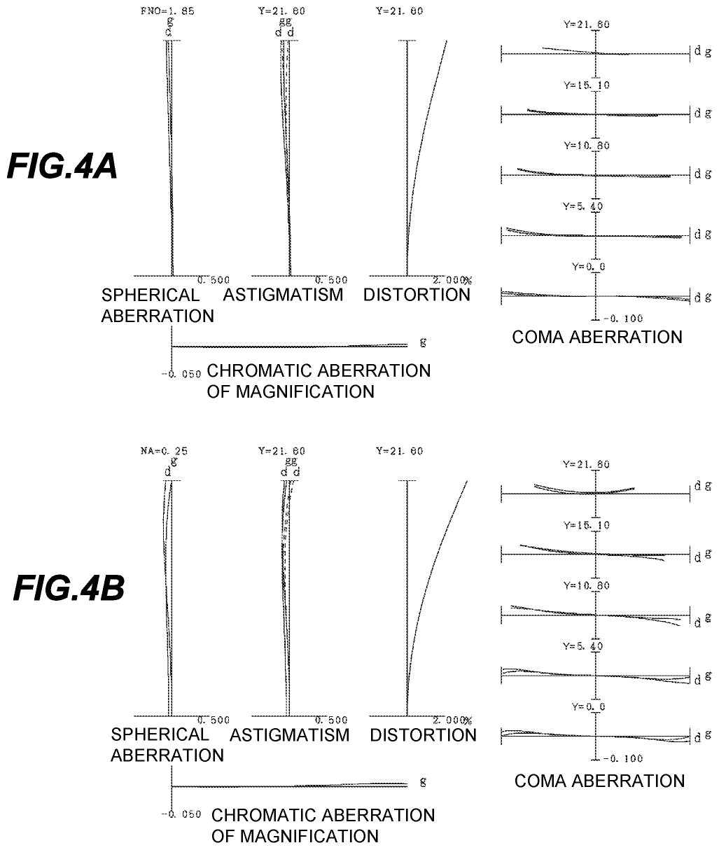

Example 2 will be described with reference to FIGS. 3 and 4 and Table 2. FIG. 3 is a diagram showing a lens configuration of the optical system according to Example 2. An optical system OL(2) according to Example 2 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a positive meniscus lens L12 having a convex surface facing an object, a cemented lens in which a biconvex positive lens L13 and a biconcave negative lens L14 are cemented, and a positive meniscus lens L15 having a convex surface facing an object. The second lens group G2 comprises a negative meniscus lens L21 having a convex surface facing an object.

The third lens group G3 comprises, in order from the object along the optical axis, a cemented lens in which a negative meniscus lens L31 having a convex surface facing an object and a positive meniscus lens L32 having a convex surface facing an object are cemented, and a biconvex positive lens L33. The fourth lens group G4 comprises a negative meniscus lens L41 having a convex surface facing an object.

The fifth lens group G5 comprises, in order from the object along the optical axis, a positive meniscus lens L51 having a convex surface facing an object and a negative meniscus lens L52 having a concave surface facing an object. An image surface I is disposed on an image side of the fifth lens group G5. A parallel plate PP is disposed between the fifth lens group G5 and the image surface I.

The following Table 2 lists values of data of the optical system according to Example 2.

TABLE 2
[General Data]

| | |
|---|---|
| f = 84.853 | fA = 83.808 |
| FNO = 1.855 | fB = 70.031 |
| 2ω = 28.002 | βF1 = 4.398 |
| Y = 21.600 | βF2 = 1.236 |
| TL = 114.050 | MF1 = 8.031 |
| Bf = 1.000 | MF2 = 5.000 |
| TL (a) = 113.505 | |
| Bf (a) = 11.205 | |

[Lens Data]

| Surface | | | | |
|---|---|---|---|---|
| Number | R | D | nd | νd |
| 1 | 57.5903 | 6.716 | 1.8081 | 22.76 |
| 2 | 250.0000 | 4.134 | | |
| 3 | 54.4191 | 3.242 | 1.7725 | 49.60 |
| 4 | 87.8376 | 0.100 | | |
| 5 | 42.6165 | 6.392 | 1.4560 | 91.37 |
| 6 | −1029.0613 | 1.200 | 2.0007 | 25.46 |
| 7 | 30.7264 | 7.020 | | |
| 8 | 33.1538 | 7.106 | 1.4978 | 82.57 |
| 9 | 2847.8763 | 2.046 | | |
| 10 | ∞ | (D10) | | (Aperture |
| | | | | Stop S) |
| 11 | 1361.3846 | 1.200 | 1.5530 | 55.07 |
| 12 | 35.8243 | (D12) | | |
| 13 | 105.7816 | 1.200 | 1.8052 | 25.46 |
| 14 | 30.0129 | 5.549 | 1.7292 | 54.67 |
| 15 | 177.6261 | 7.465 | | |
| 16 | 70.0000 | 6.745 | 2.0007 | 25.46 |
| 17 | −91.9564 | (D17) | | |
| 18 | 135.9285 | 1.200 | 1.6730 | 38.26 |
| 19 | 50.2105 | (D19) | | |
| 20 | 85.3901 | 2.439 | 2.0010 | 29.13 |
| 21 | 157.8735 | 6.189 | | |
| 22 | −36.1082 | 4.843 | 1.8081 | 22.76 |
| 23 | −200.0000 | 9.150 | | |
| 24 | ∞ | 1.600 | 1.5168 | 63.88 |
| 25 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 84.853 | β = −0.034 | β = −0.120 |
| D0 | ∞ | 2544.448 | 725.082 |
| D10 | 1.500 | 3.593 | 9.531 |
| D12 | 11.802 | 9.709 | 3.771 |
| D17 | 6.374 | 7.694 | 11.374 |
| D19 | 7.839 | 6.518 | 2.839 |

[Lens Group Data]

| | First | Focal |
|---|---|---|
| Group | surface | length |
| G1 | 1 | 83.808 |
| G2 | 11 | −66.556 |
| G3 | 13 | 40.059 |
| G4 | 18 | −118.979 |
| G5 | 20 | −84.660 |

FIG. 4A is a graph showing various aberrations of the optical system according to Example 2 upon focusing on infinity. FIG. 4B is a graph showing various aberrations of the optical system according to Example 2 upon focusing on a short-distance object.

From the graphs showing various aberrations, it can be seen that the optical system according to Example 2 is satisfactorily corrected for various aberrations and has excellent imaging performance over the entire range from upon focusing on infinity to upon focusing on a short-distance object.

### Example 3

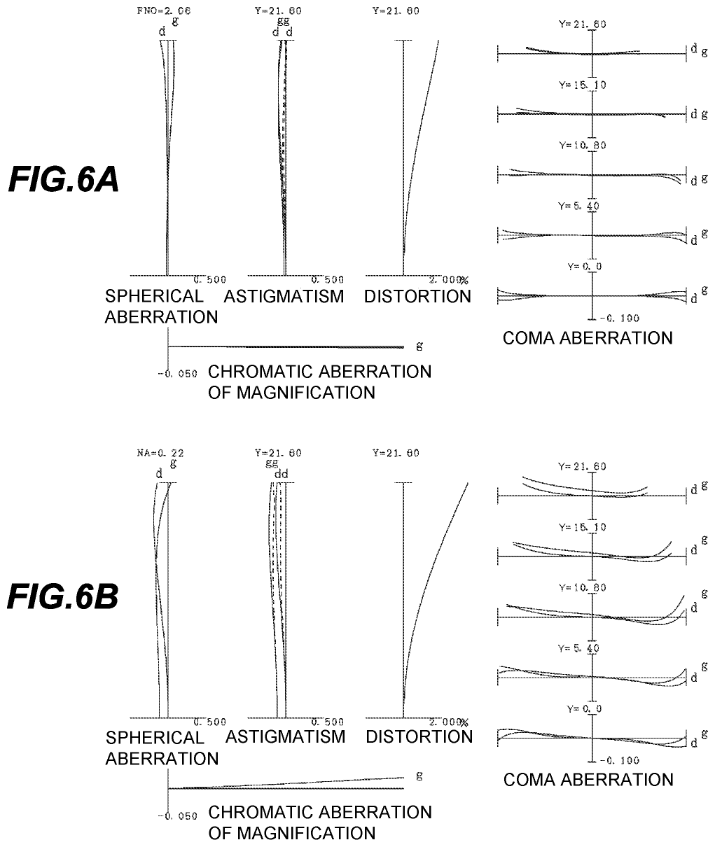

Example 3 will be described with reference to FIGS. 5 and 6 and Table 3. FIG. 5 is a diagram showing a lens configuration of the optical system according to Example 3. An optical system OL(3) according to Example 3 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a positive meniscus lens L12 having a convex surface facing an object, and a cemented lens in which a biconvex positive lens L13 and a biconcave negative lens L14 are cemented. The second lens group G2 comprises a negative meniscus lens L21 having a convex surface facing an object.

The third lens group G3 comprises a biconvex positive lens L31. The fourth lens group G4 comprises a negative meniscus lens L41 having a convex surface facing an object.

The fifth lens group G5 comprises, in order from the object along the optical axis, a positive meniscus lens L51 having a convex surface facing an object and a negative meniscus lens L52 having a concave surface facing an object. An image surface I is disposed on an image side of the fifth lens group G5. A parallel plate PP is disposed between the fifth lens group G5 and the image surface I.

The following Table 3 lists values of data of the optical system according to Example 3.

TABLE 3
[General Data]

| | |
|---|---|
| f = 82.010 | fA = 102.479 |
| FNO = 2.060 | fB = 82.146 |
| 2ω = 28.969 | βF1 = 2.495 |
| Y = 21.600 | βF2 = 1.406 |
| TL = 90.023 | MF1 = 10.381 |
| Bf = 1.000 | MF2 = 3.680 |
| TL (a) = 89.478 | |
| Bf (a) = 17.858 | |

[Lens Data]

| Surface | | | | |
|---|---|---|---|---|
| Number | R | D | nd | νd |
| 1 | 46.5771 | 5.350 | 1.7725 | 49.60 |
| 2 | 179.4303 | 0.100 | | |
| 3 | 40.3285 | 4.836 | 1.4970 | 81.61 |
| 4 | 129.0466 | 0.100 | | |
| 5 | 33.5684 | 6.218 | 1.4560 | 91.37 |
| 6 | −229.0734 | 1.000 | 1.9004 | 37.37 |
| 7 | 29.9047 | 5.182 | | |
| 8 | ∞ | (D8) | | (Aperture |
| | | | | Stop S) |
| 9 | 88.7347 | 1.000 | 1.4875 | 70.23 |
| 10 | 33.2383 | (D10) | | |
| 11 | 40.9864 | 8.072 | 1.7130 | 53.87 |
| 12 | −66.9077 | (D12) | | |
| 13 | 159.0319 | 1.157 | 1.5814 | 40.75 |
| 14 | 37.2505 | (D14) | | |
| 15 | 46.6687 | 2.874 | 1.8590 | 22.73 |
| 16 | 78.4005 | 7.093 | | |
| 17 | −26.5540 | 3.000 | 1.9037 | 31.31 |
| 18 | −63.6154 | 15.803 | | |
| 19 | ∞ | 1.600 | 1.5168 | 63.88 |
| 20 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 82.010 | β = −0.032 | β = −0.113 |
| D0 | ∞ | 2519.887 | 756.709 |
| D8 | 1.066 | 3.911 | 11.447 |
| D10 | 17.056 | 14.211 | 6.675 |
| D12 | 1.148 | 2.146 | 4.829 |
| D14 | 6.369 | 5.372 | 2.688 |

[Lens Group Data]

| | First | Focal |
|---|---|---|
| Group | surface | length |
| G1 | 1 | 102.479 |
| G2 | 9 | −109.666 |
| G3 | 11 | 36.793 |
| G4 | 13 | −83.956 |
| G5 | 15 | −101.166 |

FIG. 6A is a graph showing various aberrations of the optical system according to Example 3 upon focusing on infinity. FIG. 6B is a graph showing various aberrations of the optical system according to Example 3 upon focusing on a short-distance object. From the graphs showing various aberrations, it can be seen that the optical system according to Example 3 is satisfactorily corrected for various aberrations and has excellent imaging performance over the entire range from upon focusing on infinity to upon focusing on a short-distance object.

### Example 4

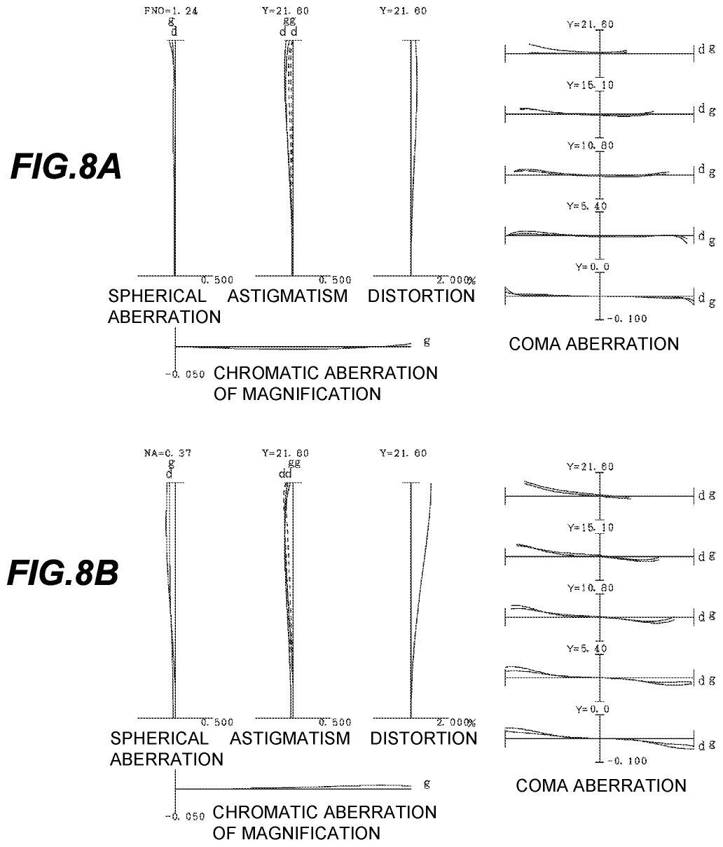

Example 4 will be described with reference to FIGS. 7 and 8 and Table 4. FIG. 7 is a diagram showing a lens configuration of the optical system according to Example 4. An optical system OL(4) according to Example 4 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a cemented lens in which a positive meniscus lens L12 having a convex surface facing an object and a negative meniscus lens L13 having a convex surface facing an object are cemented, and a cemented lens in which a biconvex positive lens L14 and a biconcave negative lens L15 are cemented. The second lens group G2 comprises a negative meniscus lens L21 having a convex surface facing an object.

The third lens group G3 comprises, in order from the object along the optical axis, a negative meniscus lens L31 having a concave surface facing an object, a positive meniscus lens L32 having a concave surface facing an object, and a biconvex positive lens L33. The fourth lens group G4 comprises a negative meniscus lens L41 having a convex surface facing an object.

The fifth lens group G5 comprises, in order from the object along the optical axis, a negative meniscus lens L51 having a convex surface facing an object, a positive meniscus lens L52 having a convex surface facing an object, and a negative meniscus lens L53 having a concave surface facing an object. An image surface I is disposed on an image side of the fifth lens group G5. A parallel plate PP is disposed between the fifth lens group G5 and the image surface I.

The following Table 4 lists values of data of the optical system according to Example 4.

TABLE 4
[General Data]

| | |
|---|---|
| f = 84.453 | fA = 118.522 |
| FNO = 1.242 | fB = 61.307 |
| 2ω = 28.622 | βF1 = 3.780 |
| Y = 21.600 | BF2 = 1.316 |
| TL = 130.011 | MF1 = 10.784 |
| Bf = 1.000 | MF2 = 4.592 |
| TL (a) = 129.465 | |
| Bf (a) = 11.185 | |

[Lens Data]

| Surface | | | | |
|---|---|---|---|---|
| Number | R | D | nd | νd |
| 1 | 73.2143 | 10.224 | 1.8929 | 20.36 |
| 2 | 453.0360 | 0.100 | | |
| 3 | 54.5976 | 9.054 | 1.5503 | 75.49 |
| 4 | 258.6524 | 1.000 | 1.7283 | 28.46 |
| 5 | 39.1638 | 1.660 | | |
| 6 | 45.1558 | 12.609 | 1.5928 | 68.62 |
| 7 | −100.3906 | 1.000 | 1.9229 | 20.88 |
| 8 | 119.0758 | 4.000 | | |
| 9 | ∞ | (D9) | | (Aperture |
| | | | | Stop S) |
| 10 | 361.2899 | 1.000 | 1.5530 | 55.07 |
| 11 | 47.0735 | (D11) | | |
| 12 | −36.4250 | 1.300 | 1.6398 | 34.47 |
| 13 | −49.6895 | 0.100 | | |
| 14 | −131.6092 | 5.891 | 1.7292 | 54.67 |
| 15 | −54.7849 | 0.100 | | |
| 16 | 50.6772 | 14.609 | 1.7725 | 49.60 |
| 17 | −230.5704 | (D17) | | |
| 18 | 113.4024 | 1.000 | 1.8081 | 22.74 |
| 19 | 52.3424 | (D19) | | |
| 20 | 89.2568 | 1.000 | 1.9229 | 20.88 |
| 21 | 36.4463 | 0.100 | | |
| 22 | 36.3836 | 9.726 | 1.9591 | 17.47 |
| 23 | 183.6004 | 8.074 | | |
| 24 | −38.1283 | 1.000 | 1.7408 | 27.79 |
| 25 | −98.0949 | 9.130 | | |
| 26 | ∞ | 1.600 | 1.5168 | 63.88 |
| 27 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 84.453 | β = −0.043 | β = −0.087 |
| D0 | ∞ | 2018.279 | 1007.763 |
| D9 | 2.000 | 6.974 | 12.784 |
| D11 | 21.625 | 16.651 | 10.841 |
| D17 | 2.000 | 4.186 | 6.592 |
| D19 | 9.109 | 6.923 | 4.518 |

[Lens Group Data]

| | First | Focal |
|---|---|---|
| Group | surface | length |
| G1 | 1 | 118.522 |
| G2 | 10 | −97.991 |
| G3 | 12 | 43.900 |
| G4 | 18 | −121.185 |
| G5 | 20 | −251.050 |

FIG. 8A is a graph showing various aberrations of the optical system according to Example 4 upon focusing on infinity. FIG. 8B is a graph showing various aberrations of the optical system according to Example 4 upon focusing on a short-distance object. From the graphs showing various aberrations, it can be seen that the optical system according to Example 4 is satisfactorily corrected for various aberrations and has excellent imaging performance over the entire range from upon focusing on infinity to upon focusing on a short-distance object.

### Example 5

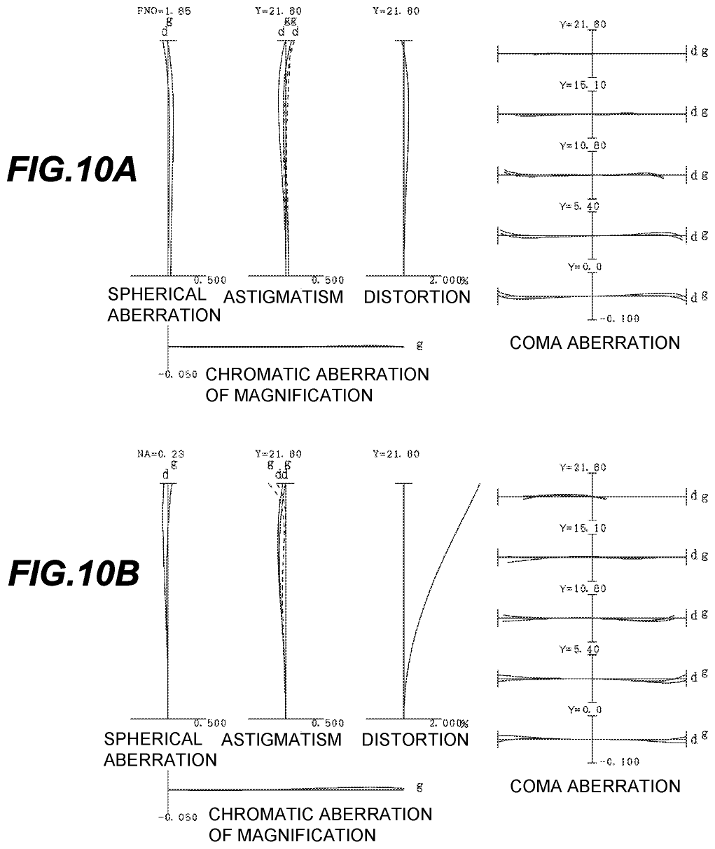

Example 5 will be described with reference to FIGS. 9 and 10 and Table 5. FIG. 9 is a diagram showing a lens configuration of the optical system according to Example 5. An optical system OL(5) according to Example 5 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a cemented lens in which a biconvex positive lens L12 and a biconcave negative lens L13 are cemented, and a cemented lens in which a negative meniscus lens L14 having a convex surface facing an object and a positive meniscus lens L15 having a convex surface facing an object are cemented. The second lens group G2 comprises a cemented lens having negative refractive power in which a positive meniscus lens L21 having a concave surface facing an object and a biconcave negative lens L22 are cemented in order from the object.

The third lens group G3 comprises, in order from the object along the optical axis, a biconvex positive lens L31 and a negative meniscus lens L32 having a concave surface facing an object. The fourth lens group G4 comprises a cemented lens having negative refractive power in which a biconvex positive lens L41 and a biconcave negative lens L42 are cemented in order from the object.

The fifth lens group G5 comprises, in order from the object along the optical axis, a cemented lens in which a negative meniscus lens L51 having a convex surface facing an object and a biconvex positive lens L52 are cemented, and a negative meniscus lens L53 having a concave surface facing an object. An image surface I is disposed on an image side of the fifth lens group G5. A parallel plate PP is disposed between the fifth lens group G5 and the image surface I.

The following Table 5 lists values of data of the optical system according to Example 5.

TABLE 5
[General Data]

| | |
|---|---|
| f = 68.369 | fA = 75.680 |
| FNO = 1.850 | fB = 52.672 |
| 2ω = 35.083 | βF1 = 6.768 |
| Y = 21.600 | βF1 = 1.291 |
| TL = 116.082 | MF1 = 11.502 |
| Bf = 1.000 | MF2 = 2.759 |
| TL (a) = 115.537 | |
| Bf (a) = 11.055 | |

[Lens Data]

| Surface | | | | |
|---|---|---|---|---|
| Number | R | D | nd | νd |
| 1 | 113.3605 | 3.581 | 1.9229 | 18.90 |
| 2 | 259.4789 | 2.000 | | |
| 3 | 64.8154 | 7.756 | 1.7495 | 35.28 |
| 4 | −305.8877 | 1.000 | 1.9229 | 18.90 |
| 5 | 89.4171 | 9.650 | | |
| 6 | 42.6939 | 1.000 | 1.9037 | 31.34 |
| 7 | 24.8498 | 8.072 | 1.6584 | 50.88 |
| 8 | 195.3643 | 2.647 | | |
| 9 | ∞ | (D9) | | (Aperture |
| | | | | Stop S) |
| 10 | −123.7398 | 2.263 | 1.8590 | 22.73 |
| 11 | −60.4222 | 1.000 | 1.5225 | 59.84 |
| 12 | 34.0422 | (D12) | | |
| 13 | 35.0724 | 8.638 | 1.6584 | 50.88 |
| 14 | −72.0999 | 0.816 | | |
| 15 | −53.1994 | 6.085 | 2.0033 | 28.27 |
| 16 | −57.0661 | (D16) | | |
| 17 | 200.0000 | 4.047 | 1.5503 | 75.50 |
| 18 | −70.0000 | 1.000 | 1.7888 | 28.43 |
| 19 | 88.7178 | (D19) | | |
| 20 | 146.9186 | 1.000 | 1.7847 | 26.29 |
| 21 | 35.2338 | 8.408 | 2.0010 | 29.14 |
| 22 | −294.1634 | 5.492 | | |
| 23 | −25.4180 | 1.000 | 1.6889 | 31.07 |
| 24 | −199.9991 | 9.000 | | |
| 25 | ∞ | 1.600 | 1.5168 | 63.88 |
| 26 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 68.369 | β = −0.028 | β = −0.148 |
| D0 | ∞ | 2500.000 | 500.000 |
| D9 | 2.021 | 4.185 | 13.522 |
| D12 | 20.093 | 17.929 | 8.591 |
| D16 | 1.418 | 1.749 | 4.177 |
| D19 | 5.496 | 5.164 | 2.737 |

[Lens Group Data]

| | First | Focal |
|---|---|---|
| Group | surface | length |
| G1 | 1 | 75.680 |
| G2 | 10 | −59.462 |
| G3 | 13 | 39.475 |
| G4 | 17 | −105.696 |
| G5 | 20 | −171.475 |

FIG. 10A is a graph showing various aberrations of the optical system according to Example 5 upon focusing on infinity. FIG. 10B is a graph showing various aberrations of the optical system according to Example 5 upon focusing on a short-distance object. From the graphs showing various aberrations, it can be seen that the optical system according to Example 5 is satisfactorily corrected for various aberrations and has excellent imaging performance over the entire range from upon focusing on infinity to upon focusing on a short-distance object.

### Example 6

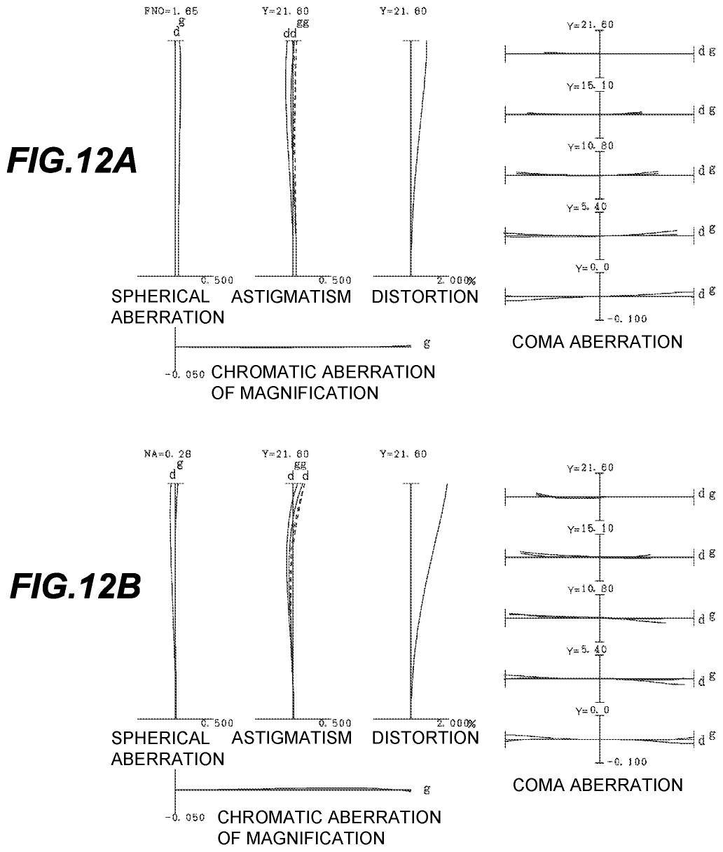

Example 6 will be described with reference to FIGS. 11 and 12 and Table 6. FIG. 11 is a diagram showing a lens configuration of the optical system according to Example 6. An optical system OL(6) according to Example 6 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a positive meniscus lens L12 having a convex surface facing an object, a cemented lens in which a positive meniscus lens L13 having a convex surface facing an object and a negative meniscus lens L14 having a convex surface facing an object are cemented, a negative meniscus lens L15 having a convex surface facing an object, and a positive meniscus lens L16 having a convex surface facing an object. The second lens group G2 comprises a cemented lens having negative refractive power in which a negative meniscus lens L21 having a convex surface facing an object and a negative meniscus lens L22 having a convex surface facing an object are cemented in order from the object.

The third lens group G3 comprises, in order from the object along the optical axis, a cemented lens in which a biconcave negative lens L31 and a biconvex positive lens L32 are cemented, a positive meniscus lens L33 having a convex surface facing an object, and a biconvex positive lens L34. The fourth lens group G4 comprises a negative meniscus lens L41 having a convex surface facing an object.

The fifth lens group G5 comprises, in order from the object along the optical axis, a cemented lens in which a biconvex positive lens L51 and a negative meniscus lens L52 having a concave surface facing an object are cemented, and a negative meniscus lens L53 having a concave surface facing an object. An image surface I is disposed on an image side of the fifth lens group G5. A parallel plate PP is disposed between the fifth lens group G5 and the image surface I.

The following Table 6 lists values of data of the optical system according to Example 6.

TABLE 6
[General Data]

| | |
|---|---|
| f = 79.983 | fA = 80.002 |
| FNO = 1.650 | fB = 58.141 |
| 2ω = 14.994 | βF1 = 3.011 |
| Y = 21.600 | βF2 = 1.339 |
| TL = 127.000 | MF1 = 8.575 |
| Bf = 1.000 | MF2 = 3.511 |
| TL (a) = 126.455 | |
| Bf (a) = 12.166 | |

[Lens Data]

| Surface | | | | |
|---|---|---|---|---|
| Number | R | D | nd | νd |
| 1 | 110.5878 | 4.985 | 1.9630 | 24.11 |
| 2 | 283.6905 | 0.100 | | |
| 3 | 63.6059 | 4.396 | 2.0033 | 28.27 |
| 4 | 89.9017 | 3.000 | | |
| 5 | 80.0000 | 5.550 | 1.6935 | 53.20 |
| 6 | 383.6873 | 1.200 | 1.8929 | 20.36 |
| 7 | 84.9195 | 5.586 | | |
| 8 | 48.6443 | 1.000 | 1.8467 | 23.78 |
| 9 | 28.2642 | 0.248 | | |
| 10 | 28.4061 | 10.976 | 1.4970 | 81.61 |
| 11 | 231.2679 | 2.922 | | |
| 12 | ∞ | (D12) | | (Aperture |
| | | | | Stop S) |
| 13 | 267.2771 | 1.500 | 1.6230 | 58.16 |
| 14 | 36.6616 | 3.000 | 1.8590 | 22.73 |
| 15 | 35.7069 | (D15) | | |
| 16 | −36.0649 | 1.000 | 1.7380 | 32.33 |
| 17 | 92.6451 | 8.190 | 1.7725 | 49.62 |
| 18 | −48.8133 | 0.100 | | |
| 19 | 64.0592 | 4.832 | 1.7725 | 49.60 |
| 20 | 306.9860 | 1.122 | | |
| 21 | 88.0545 | 5.785 | 1.9229 | 20.88 |
| 22 | −184.9624 | (D22) | | |
| 23 | 140.5931 | 1.505 | 1.6910 | 54.82 |
| 24 | 48.6168 | (D24) | | |
| 25 | 83.3736 | 11.265 | 1.8515 | 40.78 |
| 26 | −30.3564 | 1.000 | 1.8081 | 22.74 |
| 27 | −217.6682 | 3.835 | | |
| 28 | −42.0504 | 1.000 | 1.7783 | 23.91 |
| 29 | −2185.7734 | 10.111 | | |
| 30 | ∞ | 1.600 | 1.5168 | 63.88 |
| 31 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 79.983 | β = −0.032 | β = −0.113 |
| D0 | ∞ | 2544.448 | 725.082 |
| D12 | 1.300 | 3.613 | 9.875 |
| D15 | 18.706 | 16.393 | 10.131 |
| D22 | 1.300 | 2.156 | 4.812 |
| D24 | 8.887 | 8.031 | 5.375 |

[Lens Group Data]

| | First | Focal |
|---|---|---|
| Group | surface | length |
| G1 | 1 | 80.002 |
| G2 | 13 | −67.065 |
| G3 | 16 | 41.282 |
| G4 | 23 | −108.270 |
| G5 | 25 | −1174.941 |

FIG. 12A is a graph showing various aberrations of the optical system according to Example 6 upon focusing on infinity. FIG. 12B is a graph showing various aberrations of the optical system according to Example 6 upon focusing on a short-distance object. From the graphs showing various aberrations, it can be seen that the optical system according to Example 6 is satisfactorily corrected for various aberrations and has excellent imaging performance over the entire range from upon focusing on infinity to upon focusing on a short-distance object.

### Example 7

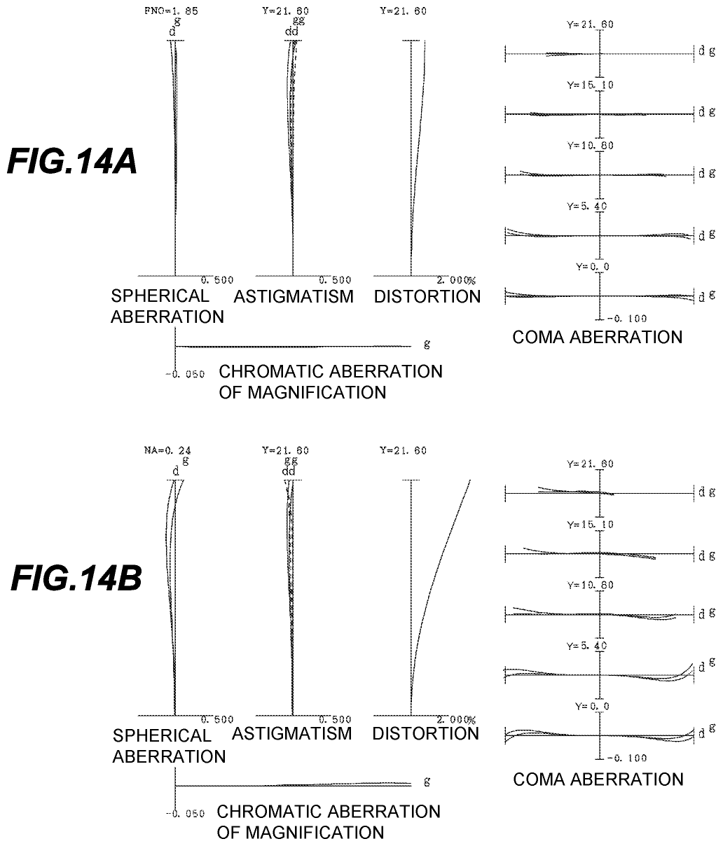

Example 7 will be described with reference to FIGS. 13 and 14 and Table 7. FIG. 13 is a diagram showing a lens configuration of the optical system according to Example 7. An optical system OL(7) according to Example 7 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the first lens group G1 and the second lens group G2. Upon focusing, the aperture stop S is located and fixed with respect to the image surface I. In the present Example, the first lens group G1 constitutes a front group GA, and the second lens group G2, the third lens group G3, the fourth lens group G4, and the fifth lens group G5 constitute a rear group GB. Further, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a cemented lens in which a biconvex positive lens L12 and a biconcave negative lens L13 are cemented, and a cemented lens in which a negative meniscus lens L14 having a convex surface facing an object and a positive meniscus lens L15 having a convex surface facing an object are cemented. The second lens group G2 comprises a cemented lens having negative refractive power in which a positive meniscus lens L21 having a concave surface facing an object and a biconcave negative lens L22 are cemented in order from the object.

The third lens group G3 comprises, in order from the object along the optical axis, a cemented lens in which a biconvex positive lens L31 and a negative meniscus lens having a concave surface facing an object are cemented, and a cemented lens in which a negative meniscus lens L33 having a convex surface facing an object and a biconvex positive lens L34 are cemented. The fourth lens group G4 comprises a cemented lens having negative refractive power in which a positive meniscus lens L41 having a concave surface facing an object and a biconcave negative lens L42 are cemented in order from the object.

The fifth lens group G5 comprises, in order from the object along the optical axis, a negative meniscus lens L51 having a convex surface facing an object, a biconvex positive lens L52, and a negative meniscus lens L53 having a concave surface facing an object. An image surface I is disposed on an image side of the fifth lens group G5. A parallel plate PP is disposed between the fifth lens group G5 and the image surface I.

The following Table 7 lists values of data of the optical system according to Example 7.

TABLE 7
[General Data]

| | |
|---|---|
| f = 72.206 | fA = 76.209 |
| FNO = 1.851 | fB = 52.016 |
| 2ω = 33.081 | βF1 = 9.569 |
| Y = 21.600 | βF2 = 1.349 |
| TL = 119.717 | MF1 = 8.426 |
| Bf = 1.013 | MF2 = 2.437 |
| TL (a) = 119.172 | |
| Bf (a) = 11.068 | |

[Lens Data]

| Surface | | | | |
|---|---|---|---|---|
| Number | R | D | nd | νd |
| 1 | 78.4114 | 3.340 | 1.9229 | 18.90 |
| 2 | 134.9023 | 9.699 | | |
| 3 | 80.8692 | 5.255 | 1.7495 | 35.28 |
| 4 | −196.7196 | 1.000 | 1.9229 | 18.90 |
| 5 | 105.8491 | 3.200 | | |
| 6 | 41.3126 | 1.000 | 1.9037 | 31.34 |
| 7 | 23.7147 | 8.842 | 1.6584 | 50.88 |
| 8 | 229.9800 | 3.085 | | |
| 9 | ∞ | (D9) | | (Aperture |
| | | | | Stop S) |
| 10 | −153.1268 | 2.349 | 1.8590 | 22.73 |
| 11 | −69.0439 | 1.000 | 1.5530 | 55.07 |
| 12 | 34.7326 | (D12) | | |
| 13 | 39.6101 | 10.055 | 1.7015 | 41.24 |
| 14 | −38.2042 | 1.520 | 1.7440 | 44.79 |
| 15 | −9186.4681 | 0.102 | | |
| 16 | 185.8765 | 2.043 | 2.0033 | 28.27 |
| 17 | 66.3539 | 5.789 | 1.7639 | 48.49 |
| 18 | −68.6833 | (D18) | | |
| 19 | −7187.8804 | 5.000 | 1.5378 | 74.70 |
| 20 | −33.8223 | 1.000 | 1.6398 | 34.47 |
| 21 | 71.5832 | (D21) | | |
| 22 | 154.3722 | 1.571 | 1.8590 | 22.73 |
| 23 | 40.6489 | 0.100 | | |
| 24 | 39.6478 | 6.587 | 1.9630 | 24.11 |
| 25 | −314.8754 | 5.215 | | |
| 26 | −25.8083 | 3.118 | 1.6668 | 33.05 |
| 27 | −200.0000 | 9.000 | | |
| 28 | ∞ | 1.600 | 1.5168 | 63.88 |
| 29 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 72.206 | β = −0.03 | β = −0.13 |
| D0 | ∞ | 2545.928 | 610.020 |
| D9 | 2.182 | 4.156 | 10.608 |
| D12 | 19.120 | 17.146 | 10.694 |
| D18 | 1.416 | 1.823 | 3.853 |
| D21 | 4.519 | 4.111 | 2.081 |

[Lens Group Data]

| | First | Focal |
|---|---|---|
| Group | surface | length |
| G1 | 1 | 76.209 |
| G2 | 10 | −58.166 |
| G3 | 13 | 36.632 |
| G4 | 19 | −82.990 |
| G5 | 22 | −115.991 |

FIG. 14A is a graph showing various aberrations of the optical system according to Example 7 upon focusing on infinity. FIG. 14B is a graph showing various aberrations of the optical system according to Example 7 upon focusing on a short-distance object. From the graphs showing various aberrations, it can be seen that the optical system according to Example 7 is satisfactorily corrected for various aberrations and has excellent imaging performance over the entire range from upon focusing on infinity to upon focusing on a short-distance object.

### Example 8

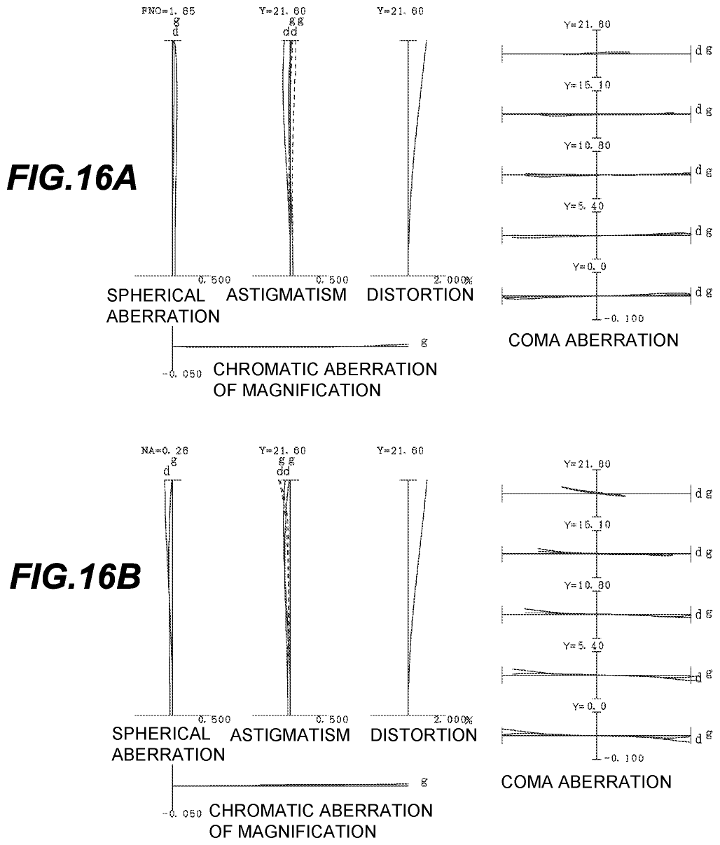

Example 8 will be described with reference to FIGS. 15 and 16 and Table 8. FIG. 15 is a diagram showing a lens configuration of the optical system according to Example 8. An optical system OL(8) according to Example 8 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the second lens group G2 and the third lens group G3. Upon focusing, the aperture stop S is located and fixed with respect to the image surface I. In the present Example, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a positive meniscus lens L11 having a convex surface facing an object, a positive meniscus lens L12 having a convex surface facing an object, a cemented lens in which a biconvex positive lens L13 and a biconcave negative lens L14 are cemented, and a positive meniscus lens L15 having a convex surface facing an object. The second lens group G2 comprises a biconcave negative lens L21.

The third lens group G3 comprises, in order from the object along the optical axis, a biconvex positive lens L31, a biconcave negative lens L32, a biconvex positive lens L33, and a biconvex positive lens L34. The fourth lens group G4 comprises a cemented lens having negative refractive power in which a biconcave negative lens L41 and a positive meniscus lens L 42 having a convex surface facing an object are cemented in order from the object.

The fifth lens group G5 comprises, in order from the object along the optical axis, a positive meniscus lens L51 having a convex surface facing an object and a negative meniscus lens L52 having a concave surface facing an object. An image surface I is disposed on an image side of the fifth lens group G5. A parallel plate PP is disposed between the fifth lens group G5 and the image surface I.

The following Table 8 lists values of data of the optical system according to Example 8.

TABLE 8
[General Data]

| | |
|---|---|
| f = 83.973 | fA = 118.595 |
| FNO = 1.850 | fB = 65.652 |
| 2ω = 28.584 | βF1 = 29.632 |
| Y = 21.600 | βF2 = 1.580 |
| TL = 139.993 | MF1 = 11.005 |
| Bf = 1.000 | MF2 = 3.781 |
| TL (a) = 139.448 | |
| Bf (a) = 12.248 | |

[Lens Data]

| Surface | | | | |
|---|---|---|---|---|
| Number | R | D | nd | νd |
| 1 | 127.9197 | 4.846 | 1.9537 | 32.32 |
| 2 | 272.7568 | 4.078 | | |
| 3 | 115.2661 | 4.962 | 1.5928 | 68.62 |
| 4 | 277.0000 | 0.100 | | |
| 5 | 87.1825 | 13.346 | 1.5503 | 75.49 |
| 6 | −77.2302 | 1.000 | 1.8548 | 24.80 |
| 7 | 128.2191 | 0.100 | | |
| 8 | 93.8240 | 4.157 | 1.9004 | 37.37 |
| 9 | 198.1148 | (D9) | | |
| 10 | −653.6377 | 1.000 | 1.5530 | 55.07 |
| 11 | 56.1988 | (D11) | | |
| 12 | ∞ | 0.970 | | (Aperture |
| | | | | Stop S) |
| 13 | 106.6668 | 5.649 | 1.8590 | 22.73 |
| 14 | −97.6967 | 12.597 | | |
| 15 | −61.1900 | 1.000 | 1.7618 | 26.52 |
| 16 | 57.3394 | 2.510 | | |
| 17 | 213.2733 | 4.668 | 1.8515 | 40.78 |
| 18 | −86.4919 | 0.100 | | |
| 19 | 53.1152 | 18.000 | 1.8160 | 46.62 |
| 20 | −78.0941 | (D20) | | |
| 21 | −2564.6832 | 1.000 | 1.9037 | 31.27 |
| 22 | 34.4236 | 4.052 | 1.5378 | 74.70 |
| 23 | 60.4235 | (D23) | | |
| 24 | 102.4782 | 4.312 | 1.9004 | 37.37 |
| 25 | 443.2418 | 4.671 | | |
| 26 | −42.4531 | 1.000 | 1.8502 | 30.05 |
| 27 | −131.6310 | 10.194 | | |
| 28 | ∞ | 1.600 | 1.5168 | 63.88 |
| 29 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 83.973 | β = −0.04 | β = −0.12 |
| D0 | ∞ | 2002.405 | 704.409 |
| D9 | 3.130 | 6.630 | 14.135 |
| D11 | 20.860 | 17.360 | 9.855 |
| D20 | 2.168 | 3.388 | 5.950 |
| D23 | 6.923 | 5.704 | 3.142 |

[Lens Group Data]

| | First | Focal |
|---|---|---|
| Group | surface | length |
| G1 | 1 | 118.595 |
| G2 | 10 | −93.536 |
| G3 | 13 | 39.296 |
| G4 | 21 | −49.646 |
| G5 | 24 | −165.859 |

FIG. 16A is a graph showing various aberrations of the optical system according to Example 8 upon focusing on infinity. FIG. 16B is a graph showing various aberrations of the optical system according to Example 8 upon focusing on a short-distance object. From the graphs showing various aberrations, it can be seen that the optical system according to Example 8 is satisfactorily corrected for various aberrations and has excellent imaging performance over the entire range from upon focusing on infinity to upon focusing on a short-distance object.

### Example 9

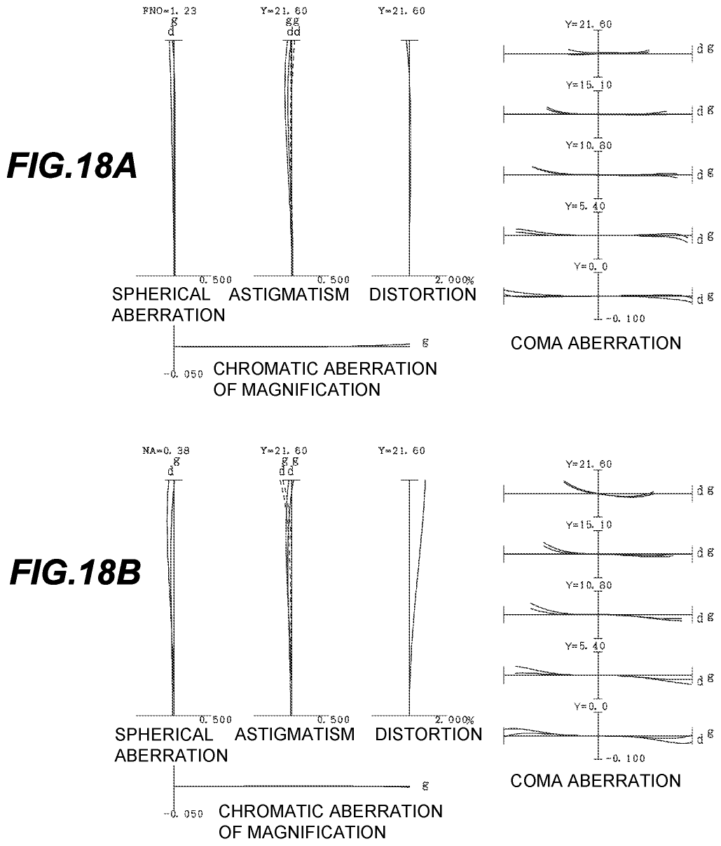

Example 9 will be described with reference to FIGS. 17 and 18 and Table 9. FIG. 17 is a diagram showing a lens configuration of the optical system according to Example 9. An optical system OL(9) according to Example 9 comprises, in order from the object along the optical axis, a first lens group G1 having positive refractive power, a second lens group G2 having negative refractive power, a third lens group G3 having positive refractive power, a fourth lens group G4 having negative refractive power, and a fifth lens group G5 having negative refractive power. Upon focusing from the infinity object to the short-distance object, the second lens group G2 and the fourth lens group G4 move toward the image side along the optical axis with different trajectories (movement amounts), and the distance between the lens groups adjacent to each other changes. Upon focusing, the first lens group G1, the third lens group G3, and the fifth lens group G5 are located and fixed with respect to the image surface I.

The aperture stop S is disposed between the second lens group G2 and the third lens group G3. Upon focusing, the aperture stop S is located and fixed with respect to the image surface I. In the present Example, the first lens group G1 corresponds to a preceding lens group GA1, the second lens group G2 corresponds to a first focusing lens group GF1, the third lens group G3 corresponds to a positive lens group GP, the fourth lens group G4 corresponds to a second focusing lens group GF2, and the fifth lens group G5 corresponds to a final lens group GE.

The first lens group G1 comprises, in order from the object along the optical axis, a biconvex positive lens L11, a cemented lens in which a biconvex positive lens L12 and a biconcave negative lens L13 are cemented, and a positive meniscus lens L14 having a convex surface facing an object. The second lens group G2 comprises a cemented lens having negative refractive power in which a biconvex positive lens L21 and a biconcave negative lens L22 are cemented in order from the object.

The third lens group G3 comprises, in order from the object along the optical axis, a biconvex positive lens L31, a cemented lens in which a biconcave negative lens L32 and a biconvex positive lens L33 are cemented, and a biconvex positive lens L34. The fourth lens group G4 comprises a cemented lens having negative refractive power in which a negative meniscus lens L41 having a convex surface facing an object and a positive meniscus lens L42 having a convex surface facing an object are cemented in order from the object.

The fifth lens group G5 comprises, in order from the object along the optical axis, a cemented lens in which a biconvex positive lens L51 and a negative meniscus lens L52 having a concave surface facing an object are cemented, and a negative meniscus lens L53 having a concave surface facing an object. An image surface I is disposed on an image side of the fifth lens group G5. A parallel plate PP is disposed between the fifth lens group G5 and the image surface I.

The following Table 9 lists values of data of the optical system according to Example 9.

TABLE 9
[General Data]

| | |
|---|---|
| f = 80.000 | fA = 101.228 |
| FNO = 1.235 | fB = 59.749 |
| 2ω = 30.268 | βF1 = 8.461 |
| Y = 21.600 | βF2 = 1.250 |
| TL = 145.575 | MF1 = 11.429 |
| Bf = 1.000 | MF2 = 5.187 |
| TL (a) = 145.030 | |
| Bf (a) = 11.275 | |

[Lens Data]

| Surface | | | | |
|---|---|---|---|---|
| Number | R | D | nd | νd |
| 1 | 183.4514 | 8.187 | 1.8830 | 40.77 |
| 2 | −3312.8103 | 0.100 | | |
| 3 | 77.4634 | 19.962 | 1.4978 | 82.57 |
| 4 | −137.5613 | 1.200 | 2.0033 | 28.27 |
| 5 | 241.0867 | 0.100 | | |
| 6 | 81.1912 | 6.450 | 1.7292 | 54.67 |
| 7 | 235.4529 | (D7) | | |
| 8 | 442.7861 | 7.699 | 1.6638 | 27.35 |
| 9 | −88.8277 | 1.200 | 1.6935 | 53.20 |
| 10 | 49.5806 | (D10) | | |
| 11 | ∞ | 7.563 | | (Aperture |
| | | | | Stop S) |
| 12 | 142.8934 | 7.834 | 1.7639 | 48.49 |
| 13 | −65.8512 | 0.677 | | |
| 14 | −58.4504 | 1.200 | 1.6989 | 30.13 |
| 15 | 43.1953 | 8.580 | 1.8160 | 46.62 |
| 16 | −30004.8580 | 0.400 | | |
| 17 | 66.5871 | 6.934 | 1.8919 | 37.13 |
| 18 | −265.8061 | (D18) | | |
| 19 | 98.5961 | 1.200 | 1.6889 | 31.07 |
| 20 | 38.2743 | 2.661 | 1.9861 | 16.48 |
| 21 | 43.0852 | (D21) | | |
| 22 | 140.5125 | 8.022 | 1.7639 | 48.49 |
| 23 | −40.8933 | 1.200 | 1.7205 | 34.71 |
| 24 | −1018.3630 | 5.378 | | |
| 25 | −36.5515 | 1.200 | 1.6989 | 30.13 |
| 26 | −200.0000 | 9.220 | | |
| 27 | ∞ | 1.600 | 1.5168 | 63.88 |
| 28 | ∞ | Bf | | |

[Variable Distance Data]

| | | Upon focusing on | Upon focusing on |
|---|---|---|---|
| | Upon focusing | an intermediate | a very short |
| | on infinity | distance object | distance object |
| | f = 80.000 | β = −0.03 | β = −0.11 |
| D0 | ∞ | 2607.240 | 732.487 |
| D7 | 3.170 | 5.986 | 14.599 |
| D10 | 18.577 | 15.761 | 7.148 |
| D18 | 2.100 | 3.486 | 7.287 |
| D21 | 12.160 | 10.774 | 6.973 |

[Lens Group Data]

| | First | Focal |
|---|---|---|
| Group | surface | length |
| G1 | 1 | 101.228 |
| G2 | 8 | −78.670 |
| G3 | 12 | 43.569 |
| G4 | 19 | −131.418 |
| G5 | 22 | −135.408 |

FIG. 18A is a graph showing various aberrations of the optical system according to Example 9 upon focusing on infinity. FIG. 18B is a graph showing various aberrations of the optical system according to Example 9 upon focusing on a short-distance object. From the graphs showing various aberrations, it can be seen that the optical system according to Example 9 is satisfactorily corrected for various aberrations and has excellent imaging performance over the entire range from upon focusing on infinity to upon focusing on a short-distance object.

### Example 10

Example 10 will be described with reference to FIGS. 19 to 21 and Table 10. FIG. 19 is a diagram showing a lens configuration of the optical system according to Example 10. An optical system OL(10) according to Example 10 comprises, in order from the object along the optical axis, a first lens group G1 having positive refractive power, a second lens group G2 having negative refractive power, a third lens group G3 having positive refractive power, a fourth lens group G4 having negative refractive power, a fifth lens group G5 having positive refractive power, a sixth lens group G6 having negative refractive power, a seventh lens group G7 having negative refractive power, and an eighth lens group G8 having positive refractive power. Upon zooming from the wide-angle end state (W) to the telephoto end state (T), the first to eighth lens groups G1 to G8 move toward the object side along the optical axis, and the distance between the lens groups adjacent to each other changes. Further, upon focusing from the infinity object to the short-distance object, the fourth lens group G4 and the sixth lens group G6 move toward the image side along the optical axis with different trajectories (movement amounts). Upon focusing, the first lens group G1, the second lens group G2, the third lens group G3, the fifth lens group G5, the seventh lens group G7, and the eighth lens group G8 are located and fixed with respect to the image surface I.

The aperture stop S is disposed between the third lens group G3 and the fourth lens group G4. Upon zooming, the aperture stop S moves along the optical axis together with the third lens group G3. Upon focusing, the aperture stop S is located and fixed with respect to the image surface I together with the third lens group G3. In the present Example, the first lens group G1, the second lens group G2, and the third lens group G3 constitute a front group GA, and the fourth lens group G4, the fifth lens group G5, the sixth lens group G6, the seventh lens group G7, and the eighth lens group G8 constitute a rear group GB. Further, the first lens group G1, the second lens group G2, and the third lens group G3 correspond to a preceding lens group GA1. The fourth lens group G4 corresponds to a first focusing lens group GF1, the fifth lens group G5 corresponds to a positive lens group GP, and the sixth lens group G6 corresponds to a second focusing lens group GF2. The seventh lens group G7 and the eighth lens group G8 correspond to a final lens group GE.

In the present Example, the parameter values corresponding to each of the conditional expressions (1) to (20) described above are parameter values in the wide-angle end state. The focal length of the preceding lens group GA1 is a focal length of the preceding lens group GA1 in the wide-angle end state, that is, a combined focal length of the first lens group G1, the second lens group G2, and the third lens group G3 in the wide-angle end state. The focal length of the final lens group GE is a focal length of the final lens group GE in the wide-angle end state, that is, a combined focal length of the seventh lens group G7 and the eighth lens group G8 in the wide-angle end state.

The first lens group G1 comprises, in order from the object along the optical axis, a cemented lens in which a negative meniscus lens L11 having a convex surface facing an object and a biconvex positive lens L12 are cemented, and a positive meniscus lens L13 having a convex surface facing an object. The second lens group G2 comprises, in order from the object along the optical axis, a negative meniscus lens L21 having a convex surface facing an object and a cemented lens in which a biconcave negative lens L22 and a positive meniscus lens L23 having a convex surface facing an object are cemented.

The third lens group G3 comprises, in order from the object along the optical axis, a biconvex positive lens L31, and a positive meniscus lens L32 having a convex surface facing an object. The fourth lens group G4 comprises a negative meniscus lens L41 having a convex surface facing an object.

The fifth lens group G5 comprises, in order from the object along the optical axis, a cemented lens in which a biconvex positive lens L51 and a negative meniscus lens L52 having a concave surface facing an object are cemented, a positive meniscus lens L53 having a concave surface facing an object, and a biconvex positive lens L54. The sixth lens group G6 comprises, in order from the object along the optical axis, a positive meniscus lens L61 having a convex surface facing an object and a negative meniscus lens L62 having a convex surface facing an object.

The seventh lens group G7 comprises a biconcave negative lens L71. The eighth lens group G8 comprises a biconvex positive lens L81. An image surface I is disposed on an image side of the eighth lens group G8. A parallel plate PP is disposed between the eighth lens group G8 and the image surface I.

The following Table 10 lists values of data of the optical system according to Example 10.

TABLE 10
[General Data]
Zooming ratio = 3.90

| | |
|---|---|
| fA = 62.983 | fB = 65.548 |
| βF1 = 6.538 | βF2 = 1.193 |
| MF1 = 4.361 | MF2 = 2.626 |

| | W | M | T |
|---|---|---|---|
| f | 50.001 | 105.261 | 194.999 |
| FNO | 4.310 | 4.680 | 5.843 |
| 2ω | 32.403 | 14.756 | 8.181 |
| Y | 14.200 | 14.200 | 14.200 |
| TL | 120.000 | 145.076 | 180.000 |
| BF | 1.000 | 1.000 | 1.000 |
| TL (a) | 119.455 | 144.531 | 179.454 |
| Bf (a) | 10.934 | 11.154 | 19.512 |

[Lens Data]

| Surface | | | | |
|---|---|---|---|---|
| Number | R | D | nd | νd |
| 1 | 600.0000 | 1.000 | 1.8548 | 24.80 |
| 2 | 155.2796 | 5.494 | 1.5378 | 74.70 |
| 3 | −103.0036 | 0.100 | | |
| 4 | 43.6041 | 3.387 | 1.4970 | 81.54 |
| 5 | 61.7534 | (D5) | | |
| 6 | 32.1528 | 1.000 | 1.4875 | 70.23 |
| 7 | 22.4574 | 7.828 | | |
| 8 | −29.4600 | 1.000 | 1.6400 | 60.08 |
| 9 | 78.0591 | 2.128 | 1.9591 | 17.47 |
| 10 | 260.3924 | (D10) | | |
| 11 | 75.7053 | 3.155 | 1.4560 | 91.37 |
| 12 | −80.2763 | 0.100 | | |
| 13 | 30.2800 | 3.198 | 1.5932 | 67.90 |
| 14 | 137.1805 | 1.507 | | |
| 15 | ∞ | (D15) | | (Aperture |
| | | | | Stop S) |
| 16 | 65.2191 | 1.000 | 1.4560 | 91.37 |
| 17 | 23.9229 | (D17) | | |
| 18 | 146.4932 | 3.856 | 1.5186 | 69.89 |
| 19 | −19.3364 | 1.000 | 2.0033 | 28.27 |
| 20 | −51.9744 | 0.126 | | |
| 21 | −50.6359 | 2.092 | 1.5378 | 74.70 |
| 22 | −34.8114 | 0.100 | | |
| 23 | 137.5873 | 2.826 | 1.8160 | 46.59 |
| 24 | −57.7362 | (D24) | | |
| 25 | 62.3570 | 2.187 | 1.8052 | 25.45 |
| 26 | 212.1498 | 0.100 | | |
| 27 | 109.1696 | 1.000 | 1.7570 | 47.86 |
| 28 | 27.2138 | (D28) | | |
| 29 | −31.9103 | 1.000 | 1.6385 | 55.34 |
| 30 | 1423.4306 | (D30) | | |
| 31 | 351.5326 | 3.000 | 1.9020 | 25.26 |
| 32 | −97.3988 | (D32) | | |
| 33 | ∞ | 1.600 | 1.5168 | 63.88 |
| 34 | ∞ | Bf | | |

[Variable Distance Data]

| | | | | Upon focusing on | | |
|---|---|---|---|---|---|---|
| | Upon focusing | | | an intermediate | | |
| | on infinity | | | distance object | | |
| | W | M | T | W | M | T |
| D5 | 2.136 | 30.400 | 34.714 | 2.136 | 30.400 | 34.714 |
| D10 | 15.274 | 4.048 | 1.000 | 15.273 | 4.048 | 1.000 |
| D15 | 1.000 | 6.133 | 12.552 | 2.010 | 6.231 | 12.803 |
| D17 | 12.641 | 5.710 | 4.455 | 11.631 | 5.613 | 4.204 |
| D24 | 20.316 | 4.001 | 1.500 | 22.316 | 6.206 | 2.979 |
| D28 | 7.468 | 33.900 | 18.239 | 5.468 | 31.696 | 16.760 |
| D30 | 1.503 | 1.000 | 39.299 | 1.503 | 1.000 | 39.299 |
| D32 | 8.879 | 9.100 | 17.458 | 8.879 | 9.100 | 17.458 |

| | Upon focusing on | | |
|---|---|---|---|
| | a very short | | |
| | distance object | | |
| | W | M | T |
| D5 | 2.136 | 30.400 | 34.714 |
| D10 | 15.274 | 4.048 | 1.000 |
| D15 | 5.361 | 7.542 | 14.689 |
| D17 | 8.280 | 4.302 | 2.318 |
| D24 | 22.943 | 14.670 | 16.356 |
| D28 | 4.842 | 23.232 | 3.383 |
| D30 | 1.503 | 1.000 | 39.299 |
| D32 | 8.879 | 9.100 | 17.458 |

[Lens Group Data]

| | First | Focal |
|---|---|---|
| Group | surface | length |
| G1 | 1 | 121.101 |
| G2 | 6 | −34.997 |
| G3 | 11 | 37.110 |
| G4 | 16 | −83.487 |
| G5 | 18 | 42.783 |
| G6 | 25 | −90.033 |
| G7 | 29 | −48.865 |
| G8 | 31 | 84.823 |

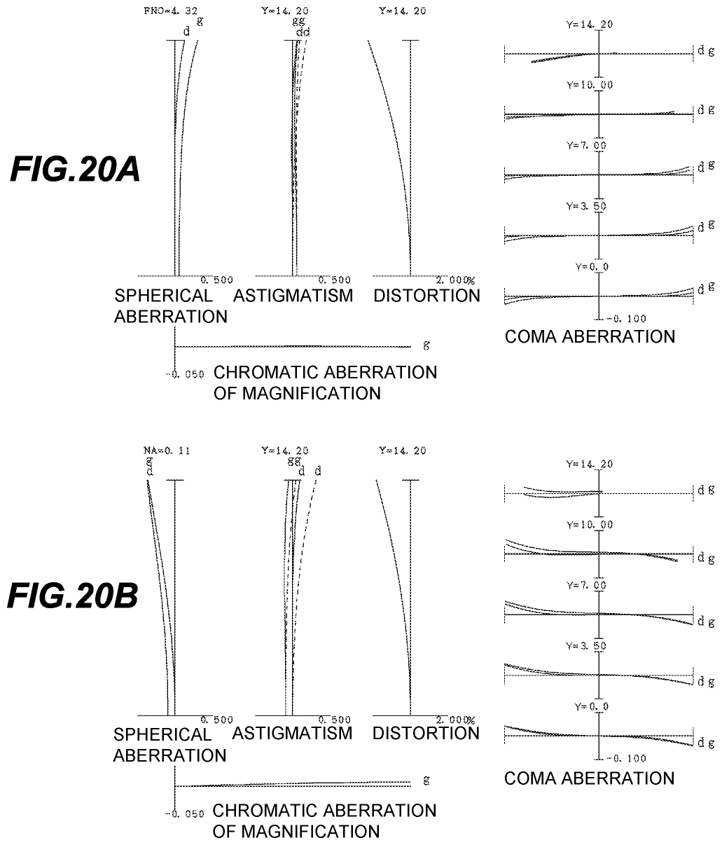

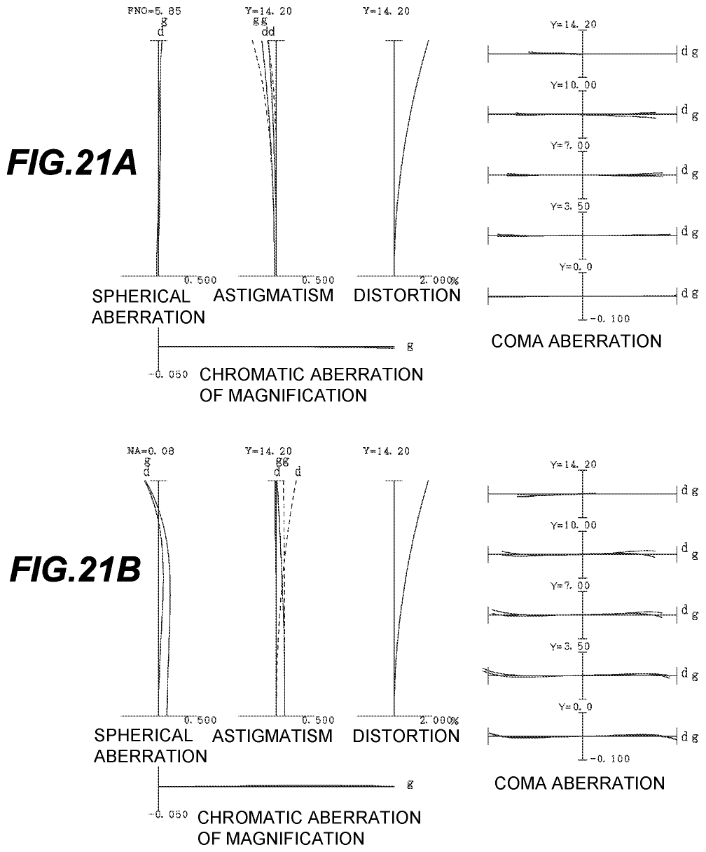

FIG. 20A is a graph showing various aberrations of the optical system according to Example 10 upon focusing on infinity in a wide-angle end state. FIG. 20B is a graph showing various aberrations of the optical system according to Example 10 upon focusing on a short-distance object in a wide-angle end state. FIG. 21A is a graph showing various aberrations of the optical system according to Example 10 upon focusing on infinity in a telephoto end state. FIG. 21B is a graph showing various aberrations of the optical system according to Example 10 upon focusing on a short-distance object in a telephoto end state. From the graphs showing various aberrations, it can be seen that the optical system according to Example 10 is satisfactorily corrected for various aberrations and has excellent imaging performance not only in the wide-angle end state but also in the telephoto end state, over the entire range from upon focusing on infinity to upon focusing on a short-distance object.

Next, a table of [Conditional expression corresponding value] is shown as follows. In this table, the values corresponding to each of conditional expressions (1) to ( 0) are summarized for all Examples (Examples 1 to 10).

Conditional Expression (1) 0.30 < STL/TL < 0.90
Conditional Expression (2) 0.50 < fA/f < 2.00
Conditional Expression (3) 0.50 < fA/(−fF1) < 1.50
Conditional Expression (4) 0.35 < fB/(−fF1) < 1.50
Conditional Expression (5) −2.00 < (−fE)/f < 15.00
Conditional Expression (6) −1.00 < fP/(−fE) < 1.50
Conditional Expression (7) 1.10 < (−fF1)/fP < 3.20
Conditional Expression (8) 0.30 < fP/f < 1.00
Conditional Expression (9) 0.10 < fF1/fF2 < 2.00
Conditional Expression (10) 0.50 < f/(−fF1) < 1.80
Conditional Expression (11) −2.50 < (rF12 + rF11)/(rF12 − rF11) < 0.00
Conditional Expression (12) 0.05 < Bf/TL < 0.80
Conditional Expression (13) −0.80 < (rR2 + rR1)/(rR2 − rR1) < 2.50
Conditional Expression (14) 0.01 < 1/βF1 < 0.60
Conditional Expression (15) 0.50 < 1/βF2 < 0.95
Conditional Expression (16) {βF1 + (1/βF1) }⁻² < 0.20
Conditional Expression (17) {βF2 + (1/βF2) }⁻² ≤ 0.25
Conditional Expression (18) 0.15 < MF1/MF2 < 0.80
Conditional Expression (19) 20.000° < 2ω < 40.00°
Conditional Expression (20) 0.08 < Bf/f < 1.20

[Conditional Expression Corresponding Value] (Examples 1 to 4)

| Conditional | | | | |
|---|---|---|---|---|
| Expression | Example 1 | Example 2 | Example 3 | Example 4 |
| (1) | 0.705 | 0.670 | 0.751 | 0.698 |
| (2) | 1.027 | 0.988 | 1.250 | 1.403 |
| (3) | 1.094 | 1.259 | 0.934 | 1.210 |
| (4) | 0.788 | 1.052 | 0.749 | 0.626 |
| (5) | 7.028 | 0.998 | 1.234 | 2.973 |
| (6) | 0.090 | 0.473 | 0.364 | 0.175 |
| (7) | 1.490 | 1.661 | 2.981 | 2.232 |
| (8) | 0.630 | 0.472 | 0.449 | 0.520 |
| (9) | 0.271 | 0.559 | 1.306 | 0.809 |
| (10) | 0.939 | 0.784 | 1.337 | 1.160 |
| (11) | −1.192 | −1.054 | −2.198 | −1.300 |
| (12) | 0.087 | 0.099 | 0.200 | 0.086 |
| (13) | 1.661 | 1.441 | 2.433 | 2.272 |
| (14) | 0.384 | 0.227 | 0.401 | 0.265 |
| (15) | 0.889 | 0.809 | 0.711 | 0.760 |
| (16) | 0.112 | 0.047 | 0.119 | 0.061 |
| (17) | 0.247 | 0.239 | 0.223 | 0.232 |
| (18) | 0.648 | 0.623 | 0.355 | 0.426 |
| (19) | 28.285 | 28.002 | 28.996 | 28.631 |
| (20) | 0.128 | 0.132 | 0.218 | 0.132 |

[Conditional Expression Corresponding Value] (Examples 5 to 8)

| Conditional | | | | |
|---|---|---|---|---|
| Expression | Example 5 | Example 6 | Example 7 | Example 8 |
| (1) | 0.696 | 0.688 | 0.707 | 0.591 |
| (2) | 1.107 | 1.000 | 1.055 | 1.412 |
| (3) | 1.273 | 1.193 | 1.310 | 1.268 |
| (4) | 0.886 | 0.867 | 0.894 | 0.702 |
| (5) | 2.508 | 14.690 | 1.606 | 1.975 |
| (6) | 0.230 | 0.035 | 0.316 | 0.237 |
| (7) | 1.506 | 1.625 | 1.588 | 2.380 |
| (8) | 0.577 | 0.516 | 0.507 | 0.468 |
| (9) | 0.563 | 0.619 | 0.701 | 1.884 |
| (10) | 0.870 | 0.838 | 0.806 | 1.114 |
| (11) | −0.568 | −1.308 | −0.630 | −0.842 |
| (12) | 0.096 | 0.096 | 0.093 | 0.088 |
| (13) | 1.291 | 1.039 | 1.296 | 1.952 |
| (14) | 0.148 | 0.332 | 0.104 | 0.034 |
| (15) | 0.775 | 0.747 | 0.741 | 0.633 |
| (16) | 0.021 | 0.089 | 0.011 | 0.001 |
| (17) | 0.234 | 0.230 | 0.229 | 0.204 |
| (18) | 0.240 | 0.409 | 0.289 | 0.344 |
| (19) | 35.107 | 29.992 | 33.081 | 28.584 |
| (20) | 0.162 | 0.152 | 0.153 | 0.146 |

[Conditional Expression Corresponding Value] (Examples 9 to 10)

| Conditional | | |
|---|---|---|
| Expression | Example 9 | Example 10 |
| (1) | 0.544 | 0.609 |
| (2) | 1.265 | 1.260 |
| (3) | 1.287 | 0.754 |
| (4) | 0.759 | 0.785 |
| (5) | 1.693 | −1.696 |
| (6) | 0.322 | −0.504 |
| (7) | 1.806 | 1.951 |
| (8) | 0.545 | 0.856 |
| (9) | 0.599 | 0.927 |
| (10) | 0.983 | 1.670 |
| (11) | −1.252 | −2.159 |
| (12) | 0.078 | 0.092 |
| (13) | 1.447 | −0.566 |
| (14) | 0.118 | 0.153 |
| (15) | 0.800 | 0.838 |
| (16) | 0.014 | 0.022 |
| (17) | 0.238 | 0.242 |
| (18) | 0.454 | 0.602 |
| (19) | 30.268 | 32.403 |
| (20) | 0.141 | 0.219 |

According to each of Examples described above, it is possible to realize the optical system with less aberration fluctuation upon focusing.

Each of Examples described above indicates a specific example of the present invention, and the present invention is not limited these Examples.

The following contents can be appropriately adopted within a range in which the optical performance of the optical system according to the present embodiments is not damaged.

As Examples of the optical system of the present embodiments, the optical systems having the five-group configuration and the eight-group configuration are shown, but the present invention is not limited thereto, and optical systems having other group configurations (for example, a six-group and a nine-group) can also be configured. Specifically, a lens or a lens group may be added to the lens group closest to the object or the image surface of the optical system of the present embodiment. The lens group refers to a portion having at least one lens separated by an air distance that changes upon focusing or zooming.

The lens group or the partial lens group may be a vibration proof lens group that corrects an image blur caused by a camera shake by moving to have a component in a direction perpendicular to the optical axis or rotating (oscillating) in a direction within the surface including the optical axis.

The lens surface may be spherical or planar, and may be formed to be aspherical. When the lens surface is spherical or planar, lens processing and assembly adjustment facilitate, and deterioration of optical performance due to errors in processing and assembly adjustment can be prevented, which is preferable. Further, even when the image surface deviates, there is little deterioration in rendering performance, which is preferable.

When the lens surface is an aspherical surface, the aspherical surface may be an aspherical surface formed by grinding, a glass-molded aspherical surface which is formed into an aspherical shape from glass, or a composite type aspherical surface which is formed into an aspherical shape from resin on the surface of glass. In addition, the lens surface may be a diffractive surface, and the lens may be a gradient-index lens (GRIN lens) or a plastic lens.

The aperture stop is preferably disposed between the first lens group and the second lens group, between the second lens group and the third lens group, or between the third lens group and the fourth lens group, but a member as the aperture stop may be substituted by use of the lens frame without being provided.

Each of the lens surfaces may be provided with an anti-reflection film having high transmittance over a wide wavelength range in order to reduce flaring and ghosting and achieve high-contrast optical performance.

### EXPLANATION OF NUMERALS AND CHARACTERS

G1 first lens group
G2 second lens group
G3 third lens group
G4 fourth lens group
G5 fifth lens group
G6 sixth lens group
G7 seventh lens group
G8 eighth lens group
I image surface
S aperture stop

1. An optical system consisting of:
a front group, an aperture stop, and a rear group that are disposed in order from an object along an optical axis, wherein
the rear group comprises a first focusing lens group disposed closest to the object of the rear group and having negative refractive power, and a second focusing lens group disposed closer to an image surface than the first focusing lens group and having negative refractive power, and
upon focusing from an infinity object to a short-distance object, the first focusing lens group and the second focusing lens group move toward the image surface along the optical axis at respective different trajectories.

2. The optical system according to claim 1, wherein
the following conditional expression is satisfied:
0.30<STL/TL<0.90
where, STL: a distance along the optical axis from the aperture stop to the image surface
TL: an entire length of the optical system.

3. The optical system according to claim 1, wherein
the rear group comprises a positive lens group disposed between the first focusing lens group and the second focusing lens group and having positive refractive power, and
a position of the positive lens group is fixed with respect to the image surface upon focusing from the infinity object to the short-distance object.

4. The optical system according to claim 1, wherein
the front group consists of a preceding lens group having positive refractive power, and
the rear group comprises a positive lens group disposed between the first focusing lens group and the second focusing lens group and having positive refractive power, and a final lens group disposed closer to the image surface than the second focusing lens group.

5. An optical system comprising:
a preceding lens group having positive refractive power, a first focusing lens group having negative refractive power, a positive lens group having positive refractive power, a second focusing lens group having negative refractive power, and a final lens group that are disposed in order from an object along an optical axis, wherein
upon focusing from an infinity object to a short-distance object, the first focusing lens group and the second focusing lens group move toward an image surface along the optical axis at respective different trajectories.

6. The optical system according to claim 5, wherein
an aperture stop is disposed between the preceding lens group and the first focusing lens group.

7. The optical system according to claim 6, wherein
the following conditional expression is satisfied:
0.30<STL/TL<0.90
where, STL: a distance on the optical axis from the aperture stop to the image surface TL: an entire length of the optical system.

8. The optical system according to claim 4, wherein
the following conditional expression is satisfied:
0.50<fA/f<2.00
where, fA: a focal length of the preceding lens group
f: a focal length of the optical system.

9. The optical system according to wherein
the following conditional expression is satisfied:
0.50<fA/(−fF1)<1.50
where, fA: a focal length of the preceding lens group
fF1: a focal length of the first focusing lens group.

10. The optical system according to wherein
the following conditional expression is satisfied:
0.35<fB/(−fF1)<1.50
where, fB: a combined focal length of the lens groups disposed closer to the image surface than the first focusing lens group
fF1: a focal length of the first focusing lens group.

11. The optical system according to wherein
the following conditional expression is satisfied:
−2.00<(−fE)/f<15.00
where, fE: a focal length of the final lens group
f: a focal length of the optical system.

12. The optical system according to claim 4, wherein
the following conditional expression is satisfied:
−1.00<fP/(−fE)<1.50
where, fP: a focal length of the positive lens group
fE: a focal length of the final lens group.

13. The optical system according to claim 3, wherein
the following conditional expression is satisfied:
1.10<(−fF1)/fP<3.20
where, fF1: a focal length of the first focusing lens group
fP: a focal length of the positive lens group.

14. The optical system according to wherein
the following conditional expression is satisfied:
0.30<fP/f<1.00
where, fP: a focal length of the positive lens group
f: a focal length of the optical system.

15. The optical system according to claim 3, wherein
the positive lens group comprises a negative lens, a first positive lens, and a second positive lens that are disposed in order from the object along the optical axis.

16. The optical system according to claim 1, wherein
the following conditional expression is satisfied:
0.10<fF1/fF2<2.00
where, fF1: a focal length of the first focusing lens group
fF2: a focal length of the second focusing lens group.

17. The optical system according to wherein
the following conditional expression is satisfied:
0.50<f/(−fF1)<1.80
where, f: a focal length of the optical system
fF1: a focal length of the first focusing lens group.

18. (canceled)

19. The optical system according to claim 1, wherein
the following conditional expression is satisfied:
−2.50<(rF12+rF11)/(rF12−rF11)<0.00
where, rF11: a radius of curvature of a lens surface closest to the object in the first focusing lens group
rF12: a radius of curvature of a lens surface closest to the image surface in the first focusing lens group

20. (canceled)

21. The optical system according to claim 1, wherein
the following conditional expression is satisfied:
0.05<Bf/TL<0.80
where, Bf: a back focusing of the optical system
TL: an entire length of the optical system.

22. The optical system according to claim 1, wherein
the following conditional expression is satisfied:
−0.80<(rR2+rR1)/(rR2−rR1)<2.50
where, rR1: a radius of curvature of a lens surface on an object side in a lens disposed closest to the image surface in the optical system
rR2: a radius of curvature of a lens surface on an image surface side in the lens disposed closest to the image surface in the optical system.

23. (canceled)

24. (canceled)

25. (Cancelled

26. (canceled)

27. (canceled)

28. The optical system according to claim 1, wherein
the following conditional expression is satisfied:
20.00°<2ω<40.00°
where, 2ω: a full angle of view of the optical system.

29. The optical system according to claim 1, wherein
the following conditional expression is satisfied:
0.08<Bf/f<1.20
where, Bf: a back focusing of the optical system
f: a focal length of the optical system.

30. An optical apparatus comprising the optical system according to claim 1.

31. A method for manufacturing
either a first a optical system consisting of, a front group, an aperture stop, and a rear group that are disposed in order from an object along an optical axis, or
a second optical system consisting of a preceding lens group having positive refractive power, a first focusing lens group having negative refractive power, a positive lens group having positive refractive power, a second focusing lens group having negative refractive power, and a final lens group that are disposed in order from an object along an optical axis,
wherein for manufacturing the first optical system the method comprises a step of disposing the front group, the aperture stop and the rear group in a lens barrel so that:
the rear group comprises a first focusing lens group disposed closest to the object of the rear group and having negative refractive power, and a second focusing lens group disposed closer to an image surface than the first focusing lens group and having negative refractive power, and
upon focusing from an infinity object to a short-distance object, the first focusing lens group and the second focusing lens group move toward the image surface along the optical axis at respective different trajectories, or
for manufacturing the second optical system the method comprises a step of disposing the preceding lens group, the first focusing lens group, the positive lens group, the second focusing lens group and the final lens group in a lens barrel so that:
upon focusing from an infinity object to a short-distance object, the first focusing lens group and the second focusing lens group move toward an image surface along the optical axis at respective different trajectories.

32. (canceled)
